(19) United States
(12) Patent Application Publication
(10) Pub. No.: US 2005/0091111 A1
(43) Pub. Date: Apr. 28, 2005

(54) Network methods for interactive advertising and direct marketing

(76) Inventors: Jason W. Green, Gaithersburg, MD (US); Boris Schroder, London (GB)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 10/991,180

(22) Filed: Nov. 17, 2004

Related U.S. Application Data
(62) Division of application No. 09/655,759, filed on Sep. 5, 2000.
(60) Provisional application No. 60/160,765, filed on Oct. 21, 1999.
(60) Provisional application No. 60/175,257, filed on Jan. 10, 2000.

(51) Int. Cl. G06F 17/60

(52) U.S. Cl. 705/14

(57) ABSTRACT

In a method of interactive advertising for the Internet, a commercial link for an ad space is embedded in the text of a Web page. The contextual targeting for the page is determined by analyzing the overall content of the page or determining the presence of individual keywords within the text content of the page. A keyword that is visually distinguished from the surrounding page content triggers an ad space to display a message, which may include a product related to the text. In some embodiments, the ad space allows a user to make a purchase transaction or view an inventory of goods and services, with descriptions, all without leaving the Web page. The web page is analyzed to determine appropriate keywords within the text to associate with the ad space. Upon user interaction with the keyword, an ad space according to the invention provides a customized message that is contextually targeted to the user.

### CROSS REFERENCE TO RELATED APPLICATIONS

This application claims the benefit of U.S. Provisional Application No. 60/160,765, filed Oct. 21, 1999, and U.S. Provisional Application No. 60/175,257, filed Jan. 10, 2000.

### BACKGROUND OF THE INVENTION

1. Field of the Invention

This invention relates to methods for interactive advertising implemented in a network environment. Specifically, this invention relates to technically advanced methods for interactive advertising and direct marketing that overcome security constraints to produce improved interactivity. As a practical matter, this invention may be embodied in a system, a network, a method, a client, a server, an interface, a message format, a carrier wave, a programmed computer system, or a computer program product. Furthermore, the invention may be embodied in a banner on a web page, or any ad space that can display an advertisement, or any program or method for collecting and updating databases mentioned below.

2. Related Work

### Internet Overview

The Internet is a worldwide collection of computer networks, cooperating with each other to exchange data using a common software standard. This sharing of data, and indeed the Internet itself, is made possible through the TCP/IP protocol. TCP/IP creates a packet-switched network, a type of network intended to minimize data loss. In a packet-switched network, TCP first breaks down data into small chunks called packets. These packets also contain the Web addresses of both the sender and the recipient. The IP then processes the data through a series of routers to direct the data to its destination. The router is a piece of hardware that examines the destination addresses of the packets it receives and then passes the packets on to another router as they make their way to their final destination. When the packets arrive at their destination, TCP takes over again identifying the packets and verifying their integrity. When all of the packets have been received, TCP reassembles them into the original data. Thus, TCP/IP allows data to be reliably transported among the various connected networks comprising the Internet.

At a high level, it is understood that the World Wide Web functions such that web servers process requests from web browsers for web pages. A web server is computer software that responds to requests for web pages by sending the web page to the requesting web browser via the Internet. A web browser is a computer program that does two things: 1) goes to a web server on the Internet and requests a web page to be retrieved by the browser and 2) interprets HTML tags embedded within the web page so that the browser can display the web page appropriately. A web page is a text file that also contains HTML tags. These HTML tags are formatting instructions used by a web browser to determine how the displayed web page should appear. HTML tags can perform various other functions in addition to formatting text including embedding sounds and images in a web page, linking to other web pages, and creating tables within a web page. Because HTML tags are textual instructions which are interpreted by the browser, no compiling is necessary. Consequently, web pages can be generated in any standard text editor (word processor).

At a lower level, it is understood that web pages, web browsers, and web servers are the primary conceptual elements a user interacts with (either directly or indirectly) in “surfing” the web. However, much of the actual process behind the workings of the Web remain hidden from the user. To retrieve a web page, a user inputs the URL (as explained above, this Uniform Resource Locator is a unique address associated with a particular web page) for the web page into the web browser. A URL may be input into a web browser in various ways including typing the URL into a predefined entry area within the browser or clicking on a hyperlink that has a URL associated with it.

A web browser breaks a URL into three parts: 1) the protocol (http for example), 2) the domain or server name (www.cnn.com for example), and 3) the file name (index.HTML for example). The web browser communicates with a domain name server (DNS) to translate the human-readable domain name into a machine-readable IP address. An IP address is a unique address, represented by a 32-bit number, assigned to each individual machine connected to the Internet. An IP address is typically expressed as four 8-bit values in decimal form separated by dots (this format is referred to as a “dotted decimal number”).

IP addresses are also represented by domain names because human beings are not particularly good at remembering strings of numbers. A domain name is a group of alphanumeric characters separated by dots. A domain name can contain up to four parts (one per corresponding octet of the associated IP address). The left-most part is the host name, which specifies the name of a specific machine in a domain. The host name may be followed by third-level and second-level descriptive domain names as well. Finally, the right-most part of a domain name is the top-level (first-level) domain. Domain names make it easier for users to remember or even discern popular web sites (www.majorleaguebaseball.com, for example, is the web site associated with major league baseball in the United States).

In practical terms, DNS is a system of millions of name servers forming a massive distributed database. These servers are administered by millions of people and process billions of requests for names every day. Once a browser has communicated with a name server and converted the server name portion of the URL into an IP address, the browser then uses this IP address to connect to the server machine. Following the protocol that was extracted from the URL, the browser sends a get request (and may send cookies as well) to the server asking for the file name that was extracted from the URL. The server then returns the file (usually HTML text—perhaps cookies as well) to the browser for interpreting and displaying.

For those not fortunate enough to have a dedicated connection to the Internet (as many government and educational institutions do), an Internet Service Provide (ISP) is a primary option in connecting to the Internet. An ISP offers its subscribers (usually for a fee), a “true” Internet connection. It is a true Internet connection in the sense that a connected computer will use the TCP/IP protocol to communicate with the Internet, as opposed to a proprietary protocol such as that used by America Online (AOL) subscribers. ISPs may offer access by various means including dial-in modems, cable modems, etc.

Accessing a web page is relatively simple when the URL (or associated IP address) of the web page is known. Because web users may not always have this information, search engines (www.yahoo.com, for example) are a useful tool for finding web pages. A search engine is a database system designed to index internet addresses. Generally, a search engine will contain a special program called a “spider,” “bot,” or “crawler”. The spider, given a URL, performs an automated process that results in a site being indexed into the database.

Search engines also allow web users to enter search queries. Two primary forms of search queries include keyword form (www.altavista.com processes keyword queries) and natural language form (www.askjeeves.com processes natural language queries). A keyword query consists of one or more potentially relevant keywords input into the search engine by a web user. The search engine then processes the keywords in the query and returns a list of web pages from within its database based on their projected relevancy in relation to the keywords. Many search engines allow keywords to be connected by Boolean logic operators (AND, OR, NOT, etc.) thereby increasing the flexibility in tailoring keyword queries. A natural language query is input as a normal interrogative question (for example, “Why is the sky blue?”). The search engine then breaks the query down into nouns and verbs, separating out the prepositional phrases. This pared down query is then processed in a similar fashion as the aforementioned keyword query.

Other languages and facilities, beyond HTML, are known.

CGI (the Common Gateway Interface) is an example of a server-side scripting language. It is a programming language that is run and interpreted at the server. JavaScript is a client-side scripting language. In other words, JavaScript is a programming language that runs inside a web browser. JavaScript code can be placed in a web page (just as HTML tags are). When a web browser loads the page, an interpreter built into the browser parses any JavaScript code and runs it.

Java is an object-oriented programming language (like Smalltalk). Java's tremendous popularity is largely due to its ability to create powerful Java applets. An applet is a program designed to be executed from within another application. In particular, as used herein, “applet” usually refers to a Java applet that runs on the client and not on the server. Java applets are stored as object code and, unlike many applications, cannot be executed directly from a normal operating system. Java applets are executed by a Java virtual machine. A web browser that is equipped with a Java virtual machine can run applets received from web servers. Applets are ideal for Internet applications accessible from a browser because they often have small file sizes, are cross platform compatible, and are highly secure.

Java applets are written in Java, and then compiled, and stored as object code in a codebase. The codebase is in a directory on a server. As with any other application, Java applets are named. Thus, any given Java applet has a name and belongs to a codebase in a directory on a server.

A Java applet can be invoked from within a web page when the web page has the “applet” HTML tag. The applet tag includes a name parameter and a codebase location parameter. The name parameter of the applet tag indicates the name of the applet that is to be retrieved and run. The codebase location parameter of the applet tag indicates and the location, on the Web, of the codebase. That is, the codebase location parameter indicates the respective URL or IP address of the codebase.

When a browser at a client is pointed toward a given URL and downloads the HTML, and the HTML includes the applet tag, the browser responds to the applet tag. In particular, the browser parses the applet tag to determine the URL or IP address of the codebase (i.e., the codebase address). The browser then issues to the codebase address an HTTP get request that indicates the name of the applet to be retrieved. The server at the codebase address retrieves the applet and performs an HTTP send operation to provide to the browser the object code to be run.

In concert with receiving the object code of the applet, the browser causes an instance of the Java virtual machine to be activated and instructs the Java virtual machine to execute the process defined by the downloaded Java applet of course, multiple Java virtual machines can be active at the same time.

There are many concerns about security in any large network, and the Internet is no exception. Web browsers are armed with particular security features to reduce the possibility that downloading the HTML of a given page and performing the operations defined by the HTML can result in unexpected mischief at the client machine. The simple display operations defined by most HTML tags pose little threat of mischief; the more powerful operations that can be undertaken with Java scripts, Java applets, and other downloadable applications do open the door to such a threat.

One concern with Java applets is that they may include commands that download to the browser content from an unexpected or undesired source. Today's browsers have a built-in safeguard that prevents such an operation. The safeguard prevents applets from successfully downloading content from a location that is different from the directory that houses the codebase. To put it another way, an applet cannot open a network connection to any server other than the one from which it was loaded. In particular, when an applet issues an HTTP get command, the HTTP get command includes in the address a parameter indicating the address of the content to be downloaded. When an applet issues such a command, the browser makes a comparison between the codebase address and the address parameter in the applet's HTTP get command. When the two addresses resolve to the same server, the HTTP get command is performed. When the two addresses fail the comparison, the HTTP get command is not performed.

This constraint is thought to make the use of Java applets reasonably safe, and is referred to as the Java “sandbox”. That is, Java applets can “play” (i.e., download and possibly execute content) in their “sandbox” (from their own server) but cannot play elsewhere.

The security concerns and situation surrounding Java applets are discussed in the reference book “HTML, The Complete Reference, Second Edition” by Thomas A. Powell, Osborne/McGraw Hill, Berkely, Calif., 1999.
Security in Java has been a serious concern from the outset. Because programs are downloaded and run automatically, a malicious program could be downloaded and run without the user being able to stop it. Java applets actually have little access to resources outside the browser's environment. Within Web pages, applets can't write to local disks or perform other harmful functions. This framework has been referred to as the “Java Sandbox.” Developers who want to provide Java functions outside the sandbox must write Java applications, which run as separate applications from browsers. (P. 294).
   Java is nevertheless highly desirable to use; it is an attractive, revolutionary approach to cross-platform development for Internet-based systems. The attractiveness is due in large measure because Java can provide a development environment in which programs can be written without regard to the particular platform on which the program will eventually run.

### Conducting Advertising

Different ways of conducting advertising on a network such as the internet will now be briefly discussed.

The product of a merchant may be thought of as being goods, services, or both. Merchants advertise their products to potential customers (also referred to as prospects). A merchant may advertise his product himself, or may hire another to do the advertising for him. Thus, an advertiser may be a merchant or another hired to do the advertising for the merchant, such as an advertising company.

To make it easier for customers to buy the products of merchants, merchants may provide catalogs. A catalog may be very large or very small, but generally contains at least a listing of one or more products available from a merchant. Sometimes, catalogs contain descriptions and even pictures relating to products. Sometimes, more than one merchant is involved in the making of a catalog, and in such cases the catalog may reflect the products of more than one merchant.

When an advertiser (such as a merchant or an advertising company) provides a catalog to a prospect, this is a form of advertising. Today, there are many ways in which catalogs and other advertisements are provided to prospects. One way in which a catalog can be provided to a prospect is an over-the-counter transfer of a hard copy version of the catalog to a prospect who comes to the store of the merchant. Another way in which a catalog can be provided to a prospect is a transfer of a copy of the catalog through the mail or some other courier service. These are the most traditional ways for an advertiser to provide a prospect with a catalog.

Not all catalogs are in hard copy form. Computer technology makes it possible to provide a catalog that is not transferred from the advertiser to the prospect in hard copy. More particularly, it is known to provide a catalog in soft copy form. A catalog in soft copy form is a catalog that is not printed on paper or the like, but a catalog in which the description of the advertised products is in a computer readable electronic format. A soft copy catalog could be distributed on a computer readable medium that is tangible, such as a CD or a diskette or the like, or it could be distributed on a computer readable medium that is intangible, such as through an electronic transmission via email.

Today, many advertisers provide soft copy catalogs that are available for access online through the internet. Here, “the internet” is meant to include not only the worldwide network that is open to the public, but any other computer network in which advertisers might provide soft copy catalogs to prospects.

One way for an advertiser to provide a soft copy catalog available for access online through the internet is to set up a site on the World Wide Web. At such a web site, the advertiser may have an interactive catalog that allows the user to browse through and even purchase the products available from one or more merchants.

One problem that advertisers face is the problem of getting the catalog or other advertisement before the prospect. With hard copy catalogs, a popular solution is simply to directly mail a hard copy of the catalog to a prospect. Another popular solution in this regard is to put copies of the catalog in convenient locations, such as near the checkout register of a store, so that the user will be encouraged to take a copy of the catalog.

With soft copy catalogs, one popular solution is to email to the prospect a link that points to the web site of the advertiser. This approach is somewhat similar to the mailing of the hard copy of the catalog to the prospect.

An approach for soft copy catalogs that is somewhat like the approach of leaving hard copies of a catalog in a convenient location is the use of banner advertisements in web pages. Banner ads are typically 468 pixels wide and 60 pixels high, although not all banner ads are this size.

A first method of implementing a banner ad is to 1 5display an image the size of a banner and use it as a large button for redirection. One manner of implementing this method is to include in the HTML of a Web page the HTML anchor tag “A” to turn an image element IMG into a link, as shown below:

<A HREF=“http://www.merchantsite.com”>
<IMG SRC=“mybanner.jpg”>
</A>

When a browser encounters the above, it displays the image “mybanner” and interprets a user activation of it (i.e., a click) as a request to leave the present Web page and to go to the Web page at “www.merchantsite.com”. Thus, activation of this type of ad space results in the redirection of a browser to a Web page at a new address, and the display produced by the browser depends solely on the HTML at the new address.

Such banner ads are static, non-interactive, and take the user to a completely different site. Users do not always mind going to a different site, but this sometimes is not desirable. Some sites are set up so that the “Back” command does not function, preventing users from returning to the original site. Thus, two problems exist with this first method of implementing an ad space. First of all, the ad content is static, and uninteresting. Secondly, users concerned about the difficulty in returning to the original site are hesitant to activate the banner.

Making ads less static is one way to make them more interesting. Several approaches have been used to make ads less static.

A second method of implementing a banner ad involves displaying an animated GIF instead of a simple image. This format was the first to permit animations that can easily be integrated into a Web page. Most browsers can show them without any plug-ins or helper applications, and they are easy to make. An animated GIF includes, within a single image file, multiple frames to be sequentially displayed, the information as to how long each is to be displayed, and whether the sequential display is to be repeated. The HTML for showing an animated GIF is substantially the same as in the first method described above:

<A HREF=“http://www.merchantsite.com”>
<IMG SRC=“myanimatedbanner.gif”>
</A>

A banner ad according to this second method is less static visually, but still suffers from the problem of lacking any interactivity, and from the problem of redirecting the user's browser to an entirely different web site.

A third method of implementing a banner ad involves using a client-side scripting language such as JavaScript. This method provides simple interactivity. Including in a Web page appropriate JavaScript commands can enable the banner ad to change from one image to another in response to the user moving his pointing device (i.e. mouse) over the ad. HTML to implement such a feature might be as follows:

```
<A HREF=“http://www.merchantsite.com”
    onMouseover=“switch(‘pic1’)”
    onMouseout=“goback(‘pic1’)”>
<IMG SRC=“mybanner1.gif”
    name=“pic1” width=“100”
    height=“25” border=“0”>
</A>
```

The above HTML displays mybanner1, and interprets an activation of it as a request to redirect the browser to www.merchantsite.com. The image at mybanner1 is named pic1. When the mouse is detected as being over the banner, the conditions for the onMouseover event are satisfied and a function of the JavaScript program (not shown) named ‘switch’ is called for pic1. This function replaces pic1 with another image. Likewise, when the mouse is detected as leaving the area of the banner, the conditions for the onMouseout event are satisfied and another function of the JavaScript program named ‘goback’ is called for pic1. This function might replace pic1 with the original image.

The third method of implementing a banner ad is the first of those discussed that offers a rudimentary level of interactivity. It can use animated GIFs, and therefore be less static. Nevertheless, the level of interactivity is quite low, and the problem of redirection to a different web site remains.

A fourth method of implementing a banner ad involves using a command-sourced display region, such as a FRAME, LAYER, or preferably an IFRAME element.

Frames are a well known feature on the Web, and are useful for causing a browser to display a window as a plurality of individual panes. Each of these individual frames may be thought of as individual windows, or frames. The benefits of using frames include allowing a user to view changeable information in one frame while using another for reference. The contents of one frame are often controlled by, or linked to, the contents of another frame—all within the same browser window. In this manner, a change to one frame (such as the user activation of a button) can cause a subsequent change in another frame (such as the display of a different document).

More particularly, a frame may generally be thought of as an independent scrolling region within a window. Frames can be nested within each other. Each frame in a browser window may have a different document sourced from a different URL. A given web page may include several frames. Each frame is displayed using the HTML instructions contained in a separate document.

When a window has a plurality of frames, there is typically an overall HTML document that defines the frames and their respective locations, as well as an HTML document for each of the frames. In HTML, a frame is often defined using a FRAME element which uses a source parameter SRC to indicate the location of the HTML commands that define for the browser how to display the frame.

Not all frames have a fixed position, however. It is possible to use the HTML tag IFRAME to define an in-line frame. An IFRAME element must include a parameter indicating the source of the HTML that tells the browser what to display in the frame. The source parameter SRC is set to the URL of the location where the HTML for the frame is. The IFRAME tag also accepts parameters for height and width.

The IFRAME tag may thus be thought of as defining a command-sourced display region. By this, it is meant that the tag can be used to define a display region whose contents can contain commands. An IMG element, by contrast, is not a command-sourced display region. The IMG tag can define a display region, but the contents pointed to by the SRC parameter of the IMG tag cannot contain commands.

Using an IFRAME tag with the height and width set to 60×468 pixels is one way to create a banner ad. The HTML for such a banner ad might be as follows:

<IFRAME SRC=“mybannercommands.htm”
WIDTH=“468” HEIGHT=“60” ALIGN=“CENTER”>

In the foregoing example, the file “mybannercommands.htm” could contain hypertext markup elements just like any other web page. Thus, a banner could be created that has an animated GIF in part of the banner, and one or more buttons in the remainder of the banner. Unlike the previous examples, the buttons could be set so that each links to a different location. Such buttons could each be scripted so as to change shape when moused over. The banner could be set to begin with one kind of display for the purpose of attracting attention, but to change to a much different display once the onMouseover event is detected with respect to the banner as a whole.

For example, the banner could display an animated GIF or other active display over the entire banner area. The banner could respond to an interaction event such as a mouseover by switching to a set of buttons for the user to select.

Using this fourth method of implementing a banner ad provides for a potentially dynamic presentation, and one that has an improved degree of interactivity.

A particular and highly preferred case of the fourth method of implementing a banner ad may be understood to be the use of non-HTML objects in the commands of the command-sourced display region. For example, the SRC file mybannercommands.htm might include a JavaScript program or an APPLET tag pointing to a Java object. In other words, the HTML which is the command source for the command-sourced IFRAME or the like includes objects that are non-HTML objects.

By employing this preferred fourth method of banner implementation, banner ads can be made more interesting and somewhat interactive. Nevertheless, the Java sandbox presents serious constraints on the degree of interactivity that can be achieved.

### SUMMARY OF THE INVENTION

It is an object of the invention to overcome the above-identified deficiencies of advertising and to provide a method, system, client, server, computer program product, carrier wave, and apparatus for so doing.

In a preferred embodiment of the invention, a web client (viz., a browser) is provided with a primary address, which may be in the form of a URL. This address may be provided to the web client directly by a user. The web client resolves the primary address and sends a primary file request (which may be an HTTP get request) to the primary address to obtain a primary target file, which may be an HTML file. At the primary address is a primary web server. The primary web server delivers to the web client the primary target file in response to the primary file request. The web client generates a display (i.e., a primary web page) based on the content of the primary target file.

The primary target file includes an ad space definition. The ad space definition, which may be an IFRAME, defines a command sourced display region and includes an ad space address. The web client, in response to detecting the ad space address, resolves the ad space address and sends an ad space file request (which may be an HTTP get request) to the ad space address to obtain an ad space target file, which may be an HTML file. At the address is an ad space server. The ad space server delivers to the web client the ad space target file in response to the ad space file request.

The ad space target file includes an interactive element indicator. The interactive element indicator, which may be an APPLET tag, indicates an interactive element for operation in relation to the ad space and includes an interactive element address. The web client, in response to detecting the interactive element address, resolves the interactive element address and sends an interactive element file request (which may be an HTTP get request) to the interactive element address to obtain an interactive element target file, which may be the object code of a Java applet. At the address is an element server. The element server responds to the interactive element file request by delivering to the web client the interactive element target file.

The interactive element target file includes computer readable statements. The web client causes the computer readable statements to be performed so as to put the interactive element in an activity receptive state at the web client. In this activity receptive state, the interactive element is responsive to user interaction with the web client to issue file requests such as file delivery and/or file transmit requests. The file requests of the interactive element may include distant file requests. The distant file requests of an interactive element include a distant target file address, and are sent to a companion element address. The distant target file address is an address different from the address of the element server, and the distant target file address identified by the distant target file address is initially unavailable at the element server.

At the element server there is defined a companion element corresponding to the interactive element. The companion element may be a SERVLET and has, as its address, the companion element address. The companion element is responsive to the distant file requests of the interactive element.

In particular, when the interactive element at the web client sends a distant file delivery request, it sends the distant file delivery request to the companion element at the companion element address at the element server. The distant file delivery request sent to the companion element includes the distant target file address. The companion element receives the distant file delivery request and resolves the distant target file address. The companion element sends a companion distant target file request to the distant target file address to obtain the distant target file, which may be any type of content. At the address is a distant server. The distant server responds to the companion distant target file request by sending the distant target file to the companion element.

The companion element receives the distant target file and stores it at the element server as a local target file corresponding to the distant target file. Here, “storing the distant target file as a local target file” does not mean storage on only hard disk, but also refers to temporary storage in any memory, including random access memory or cache.

The companion element causes the local target file to be delivered to the interactive element in satisfaction of the distant file delivery request.

In this preferred embodiment, the companion element is not an APPLET and is thus not constricted by the Java sandbox. The companion element thus makes it possible for the interactive element to obtain files from and to deliver files to a distant server.

Because files can be obtained from and delivered to a distant server, banner ads can be completely interactive, and can provide all of the functionality of a merchant site without the disadvantage of the browser being redirected to a page different from the primary web page.

The need for delivery of a distant target file from a distant file server can arise from a user interaction with the interactive element, or can also arise from an initial program load indication included in the computer readable instructions for the interactive element. Since a user interaction with an interactive element and an initial program load indication of an interactive element both represent kinds of requirements for a distant target file, it will be appreciated that the phrase “a distant target file requirement of the interactive element”, when used herein, is inclusive of interactions and initial program loads, as well as other reasons an interactive element might be required to ask for or send a distant target file.

In all of its embodiments, the invention may be used in any digital client-server type interactive environment such as the internet, in which data is exchanged and communication occurs between a viewer's client environment such as a personal computer running a world wide web browser program and another party's server environment such as a server computer on the world wide web or the medium of the internet in general. This invention is not limited to operation in the current incarnation of the internet and the world wide web, but can be applied to any interactive digital environment.

### BRIEF DESCRIPTION OF THE DRAWING FIGURES

FIG. 1 shows a workstation communicating with a web server.

FIG. 2 shows a workstation receiving a primary target file from a web server and displaying a web page.

FIG. 3 shows a workstation displaying a web page having an ad space.

FIG. 4 shows a workstation communicating with an ad space server.

FIG. 5 shows an ad space server sending an ad space target file to a workstation.

FIG. 6 shows a workstation communicating with an element server.

FIG. 7 shows a workstation receiving from an element server an interactive element target file.

FIG. 8 shows an operation that is prevented by security constraints.

FIG. 9 shows an interactive element of a workstation sending a distant file delivery request to a companion element at an element server.

FIG. 10 shows a companion distant target file request being sent from an element server to a distant file server.

FIG. 11 shows a distant target file being sent from a distant file server to an element server.

FIG. 12 shows a companion element receiving a distant target file and storing it has a local target file.

FIG. 13 shows a companion element at an element server providing a local target file to an interactive element.

FIG. 14 shows an interactive element using a local target file as an input for displaying an ad space.

FIG. 15 shows a high-level overview of the process described using FIGS. 1-14.

FIG. 16 shows a way of implementing an ad support system.

FIG. 17 shows an overall flow diagram of the manner in which advertisements are delivered, customized, initialized, and used.

FIG. 18 shows a flow diagram for serving an advertisement.

FIG. 19 shows a flow diagram for customizing an advertisement.

FIG. 20 shows a flow diagram for initial icing and advertisement.

FIG. 21 shows a flow diagram of fewer interaction with an advertisement.

FIG. 22 shows a notional web site used for showing parts of an interactive console.

FIG. 23 shows another view of the notional web site following a user interaction with the ad space.

FIG. 24 shows a web site in which a primary target page is part of a context sensitive advertising system.

FIG. 25 shows the web site of FIG. 24 but with an ad space displayed in response to detecting a user interaction.

### DETAILED DESCRIPTION OF THE PREFERRED EMBODIMENTS

Using the above-identified figures, the invention will now be described with respect to various preferred embodiments. Although many specificities will be mentioned, it must be emphasized that the scope of the invention is not to the taken to be that of only the preferred embodiments, but should be construed in accordance with the claims appended below.

Prior to describing in detail the preferred embodiments, however, certain terms will now be defined for the purposes of this description.

### Glossary

‘Ad Program’ refers to an embodiment of the invention described herein. It is a functional and interactive program that enacts the concepts and features of this invention.

‘Ad Space’ refers to any region within a website that is used to display an advertisement.

‘Advanced Platform’ refers to any device or environment that is different than the standard internet viewing platform. Typically the standard platform is a personal computer connected to an internet service provider through a modem connection through the phone system.

‘Advertisement’ refers to any promotional material of any kind whose purpose is to promote a business, product, or service of any kind. In this environment, an advertiser is typically a third party who compensates a website owner for promotional space in a website.

‘Advertiser’ refers to any party that wishes to promote their business by presenting an advertisement.

‘Bandwidth’ and ‘Connection Speed’ refer to the quality and data transfer capability of the total connection between a viewer and the source of the material that the viewer is receiving.

‘Banner’ can refer to a typical ad space presentation of standard dimensions consisting of an image, images, or animations. It also loosely refers to any presentation that fits into the typical dimensions of a banner advertisement.

‘Branding’ or ‘branded’ refers to the graphical appearance, identity, look and feel, phraseology, font, attitude, or other identifiable characteristic of any entity in a digital interactive medium.

‘Browse’ refers to the actions of a viewer as they look over, interact with, and navigate through presentations in an interactive digital medium.

‘Browser’ refers to a client program that enables a viewer to interact with the world wide web on the internet.

‘Click’ refers to the actions of a viewer as they move the cursor over a certain feature on the graphical user interface and activate that feature by pressing a button.

‘Commerce’ refers to any exchange of funds for goods or services.

‘Cookie’ refers to a feature of a browser which allows a website to store customization data on the viewer's computer for future reference.

‘Customization’ refers to the process by which a viewers preferences are remembered and fulfilled when some media is presented to that viewer.

‘Dynamic’ means frequently changed and updated, and also means adaptable to a changing environment.

‘HTML Document’ refers to a world wide web file that resides on the internet and specifies what a browser should display to a viewer.

‘HTML Tag’ refers to a part of an HTML document that specifies certain things be inserted and displayed into a website.

‘Internet’ refers to a large system of networked computers that enables a wide variety of interaction between computers world wide.

‘Loading’ refers to the transfer of data to and from the Ad Program.

‘Online’ refers to anything related to the interactive digital environment described above, such as the internet and the world wide web.

‘Opt-In’ means voluntarily requested by the viewer.

‘Plug-in’ refers to a program that runs as part of a browser on the viewer's computer, which is not a standard feature of the browser but which adds some additional functions and capabilities to it.

‘Resources’ refer to text, image, animation, sound, or any other kind of digital material that is needed by a website, program, Ad Program, or any other entity in a digital interactive medium.

‘Shopping Cart’ refers to the ability of commerce enabled websites to group together multiple products for a single transaction.

‘Streaming’ refers to a technique of transferring and presenting any media which requires large resources, such as audio and video, in which a certain portion of that media is transferred initially and buffered, after which time the media presentation begins to be displayed to the viewer. While the presentation is ongoing, the resources for that presentation continue to be transferred and buffered. This allows for a relatively short delay from request to display of a relatively large media resource.

‘Targeting’ refers to the process by which an entity in the interactive digital environment uses knowledge of the viewer or the context of the material that the viewer is viewing to better tailor the content of the website presentation to that particular viewer. This is a particularly important process in online advertising because it allows ads to be much more effective in attracting the attention of viewers, and allows the website to present ads that a particular viewer will be interested in.

‘Viewer’ refers to any person that is using any interactive digital medium, such as the internet. The viewer controls the browser or any other interface to that medium. Viewer may also be referred to as ‘user’, ‘customer’, or ‘prospect’.

‘Website’ refers to a very specific implementation of a digital interactive medium on the internet in which a viewer uses a browser to view HTML documents which contain text, multimedia presentations, interactive programs, and ad space.

‘World Wide Web’ refers to an interconnected network of HTML documents on the internet.

### Computer System

One embodiment of this invention resides in a 10 computer system referred to below as an element server. Here, the term “computer system” is to be understood to include at least a memory and a processor. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

### Computer Program Product

The above-identified invention may be embodied in a computer program product, as will now be explained.

On a practical level, the software that enables the computer system to perform the operations described further below in detail, may be supplied on any one of a variety of media. Furthermore, the actual implementation of the approach and operations of the invention are actually statements written in a programming language. Such programming language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include a diskette, a tape, a compact disc, an integrated circuit, a ROM, a CD, a cartridge, a remote transmission via a communications circuit, or any other similar medium useable by computers. For example, to supply software for enabling a computer system to operate in accordance with the invention, the supplier might provide a diskette or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a diskette, “stored in” an integrated circuit, or “carried over” a communications circuit, it will be appreciated that, for the purposes of this application, the software will be referred to as being “on” the computer readable medium. Thus, the term “on” is intended to encompass the above and all equivalent ways in which software is associated with a computer usable medium.

For the sake of simplicity, therefore, the term “program product” is thus used to refer to a computer readable medium, as defined above, which has on it any form of software to enable a computer system to operate according to certain pre-defined steps.

Thus, the invention is also embodied in a computer program product having software on a computer readable medium.

### User Interface

A user interface may be understood to mean any hardware, software, or combination of hardware and software that allows a user to interact with a computer system. For the purposes of this discussion, a user interface will be understood to include one or more user interface objects. User interface objects may include display regions, user activatable regions, and the like.

As is well understood, a display region is a region of a user interface which displays information to the user. A user activatable region is a region of a user interface, such as a button or a menu, which allows the user to take some action with respect to the user interface.

A user interface may be invoked by an application program. When an application program invokes a user interface, it is typically for the purpose of interacting with a user. It is not necessary, however, for the purposes of this invention, that an actual user ever interact with the user interface. It is also not necessary, for the purposes of this invention, that the interaction with the user interface be performed by an actual user. That is to say, it is foreseen that the user interface may have interaction with another program, such as a program created using macro programming language statements that simulate the actions of a user with respect to the user interface.

### First Preferred Embodiment

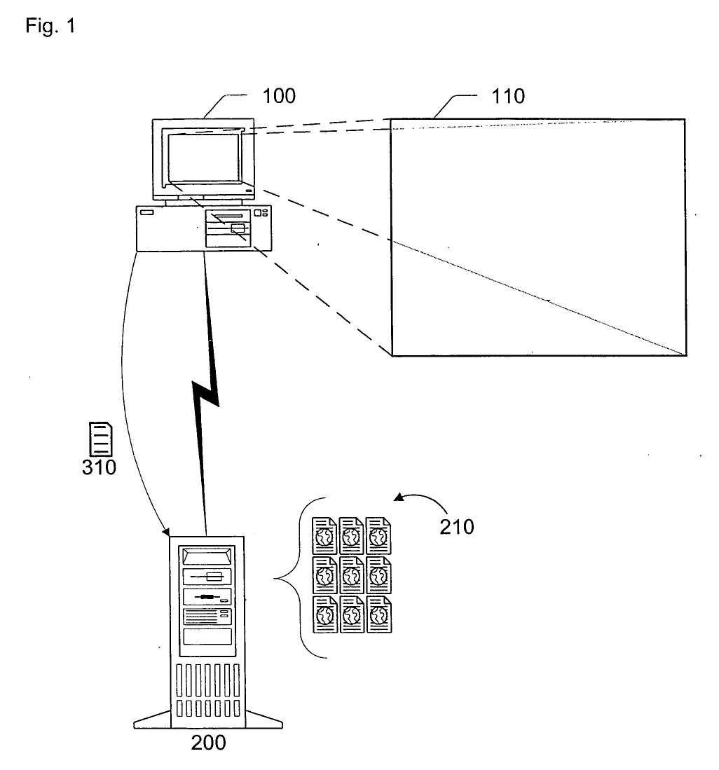

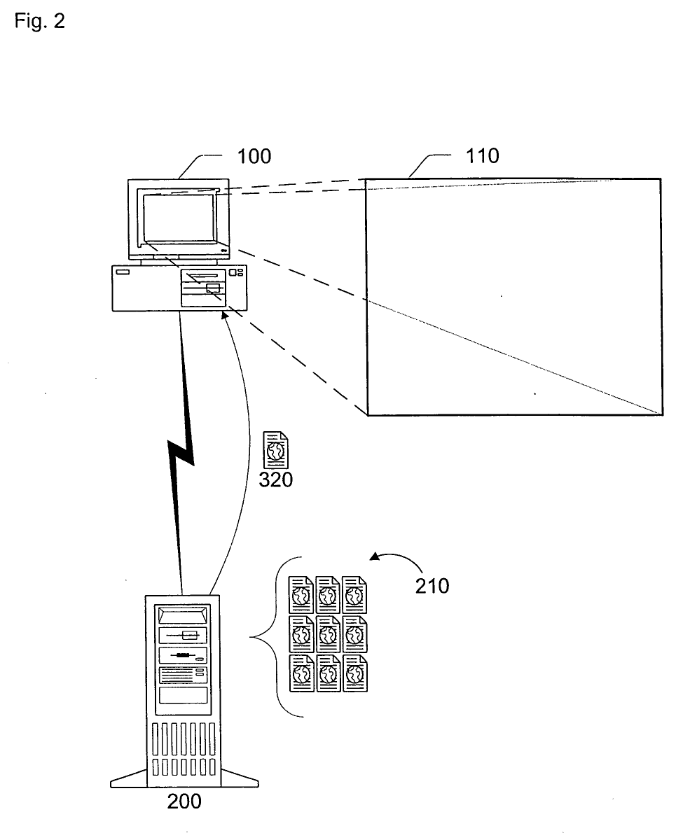

FIG. 1 shows a workstation running a web client 100. FIG. 1 shows also a web server which may be referred to as a primary web server 200 in this example. The primary web server 200 hosts a set of web pages 210 and has a particular address. The web client 100 may be a browser. The web client 100 generates a display 110, which may be a browser window. The web client 100 is provided with a primary address, which may be in the form of a URL. This address may be provided to the web client 100 directly by a user or automatically by a computer. The web client 100 resolves the primary address and sends a primary file request 310 (which may be an HTTP get request) to the primary address to obtain a primary target file, which may be an HTML file. At the primary address is the primary web server 200. See FIG. 2. When the primary target file 320 is one of the files 210 hosted by the primary web server 200, the primary web server 200 delivers to the web client 100 the primary target file 320 in response to the primary file request 310. The web client 100 generates a display 110 (i.e., a primary web page) based on the content of the primary target file 320.

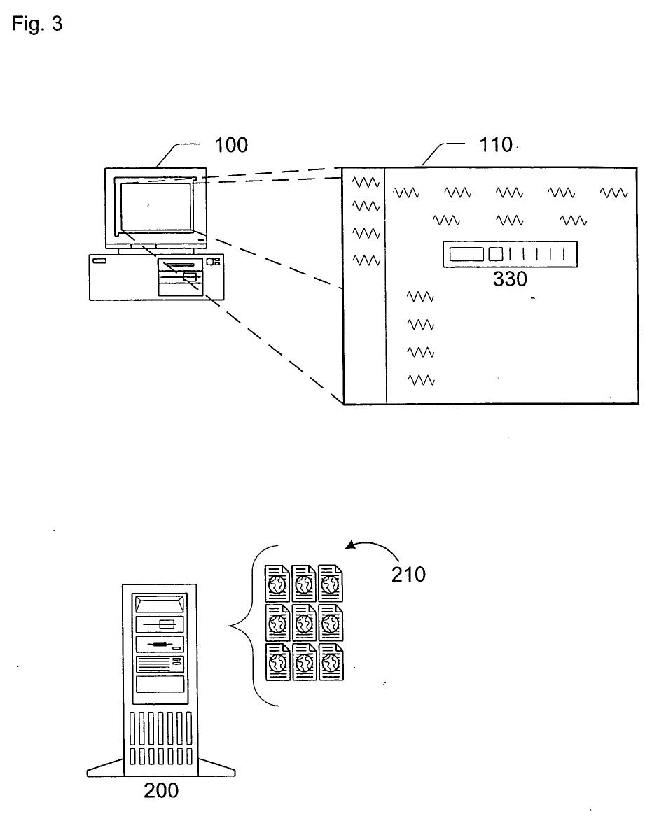

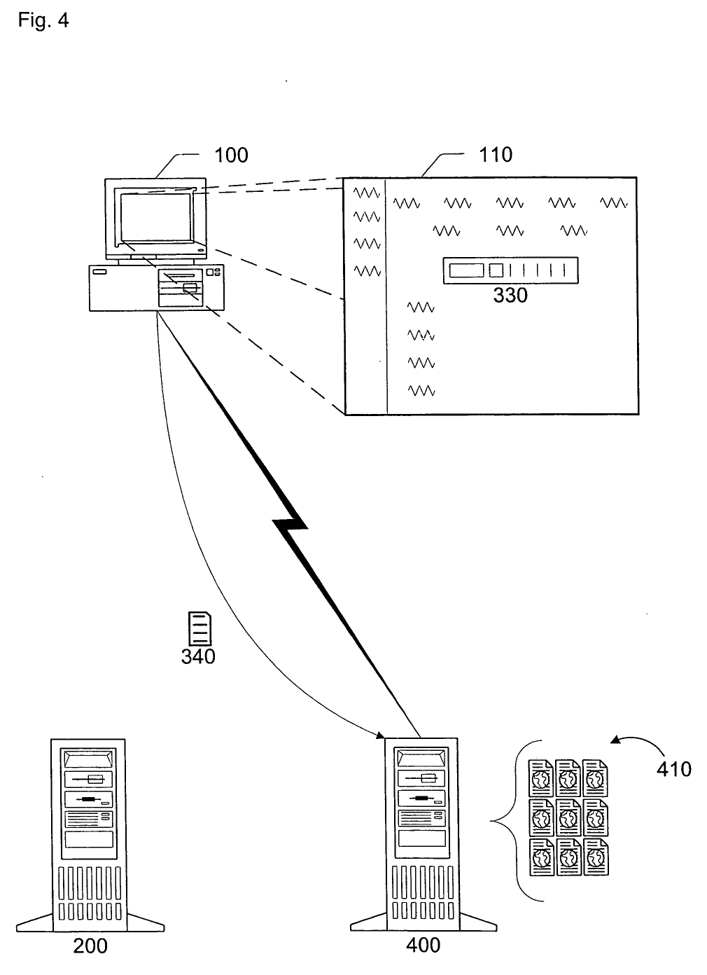

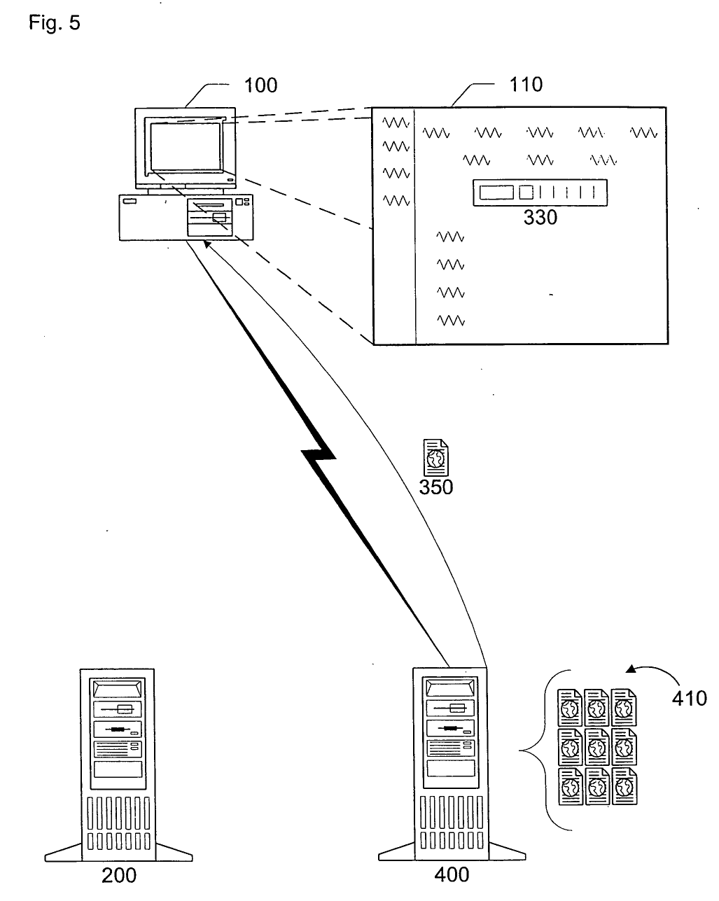

FIG. 3 shows that the web client 100 has generated the display 110 based on the content of the primary target file 320. Display 110 includes an ad space 330 by virtue of the content of the primary target file 320. In the present case, the primary target file 320 includes an ad space definition. The ad space definition, which may be an IFRAME, defines a command sourced display region and includes an ad space address. The web client 100, in response to detecting the ad space address, resolves the ad space address and (in FIG. 4) sends an ad space file request 340 (which may be an HTTP get request) to the ad space address to obtain an ad space target file, which may be an HTML file. At the address is an ad space server 400 hosting files 410. The files 410 may be HTML files. The ad space server 400, in FIG. 5, delivers to the web client 100 the ad space target file 350 in response to the ad space file request 340 (see FIG. 5).

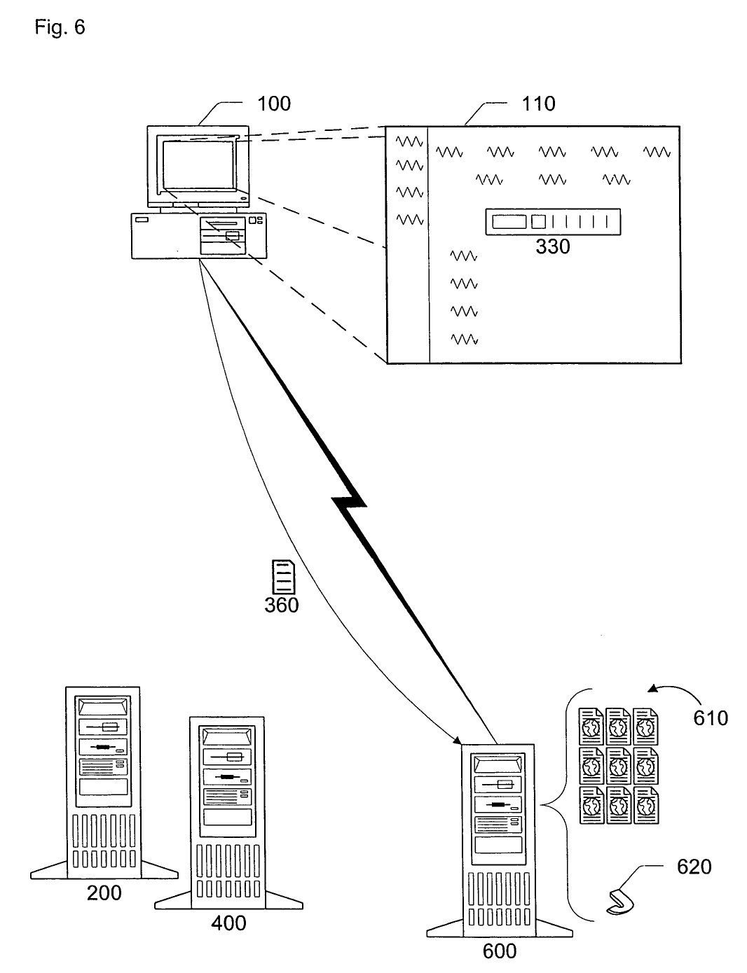

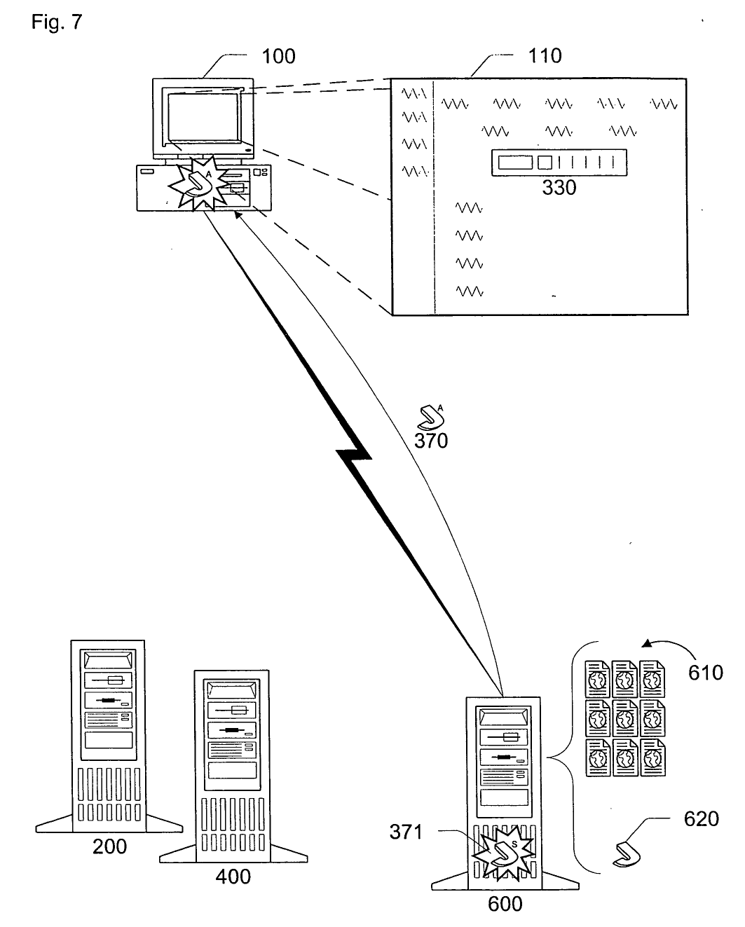

The ad space target file 350 may include an interactive element indicator. The interactive element indicator, which may be an APPLET tag, indicates an interactive element for operation in relation to the ad space 330 and includes an interactive element address. The web client 100, in response to detecting the interactive element address, resolves the interactive element address and sends an interactive element file request 360 (which may be an HTTP get request) to the interactive element address (see FIG. 6) to obtain an interactive element target file, which may be the object code of a Java applet. At the address is an element server 600. The element server 600 hosts files, including files such as HTML files 610 and a Java codebase 620. The element server 600 responds to the interactive element file request 360 by delivering (FIG. 7) to the web client 100 the interactive element 370 target file.

The interactive element 370 target file includes computer readable statements, and may be a Java applet. The interactive element 370 may also be thought of as an ad program. The web client 100 causes the computer readable statements to be performed so as to put the interactive element 370 in an activity receptive state at the web client 100. In this activity receptive state, the interactive element is responsive to user interaction with the web client 100 to issue file requests such as file delivery and/or file transmit requests.

It will be understood by one familiar with this field that the interactive element may issue file requests such as file delivery and/or file transmit requests even before entering the activity receptive state. In particular, the computer readable statements that define the interactive element may include an initial program requirement for a file delivery and/or file transmission. This may be understood to be an initial program load of the interactive element.

The file requests of the interactive element 370, whether due to user interactions, initial program loads, or other reasons, may include distant file requests.

The distant file requests of an interactive element 370 include a distant target file address, and are sent to a companion element address. The distant target file address is an address different from the address of the element server 600. When the distant file request is a distant target file delivery request, the distant target file address relates to the address of a file to be delivered to the interactive element. When the distant file request is a distant target file transmit request, the distant target file address relates to an address to which a file available to the interactive element is to be transmitted. In the former case, the distant target file identified by the distant target file address is initially unavailable at the element server. In the latter, access to the distant target file address is unavailable to the interactive element.

At the element server 600 there is defined a companion element 371 corresponding to the interactive element 370. The companion element 371 may be a SERVLET and has, as its address, the companion element 600 address. The companion element 371 is responsive to the distant file requests of the interactive element 370.

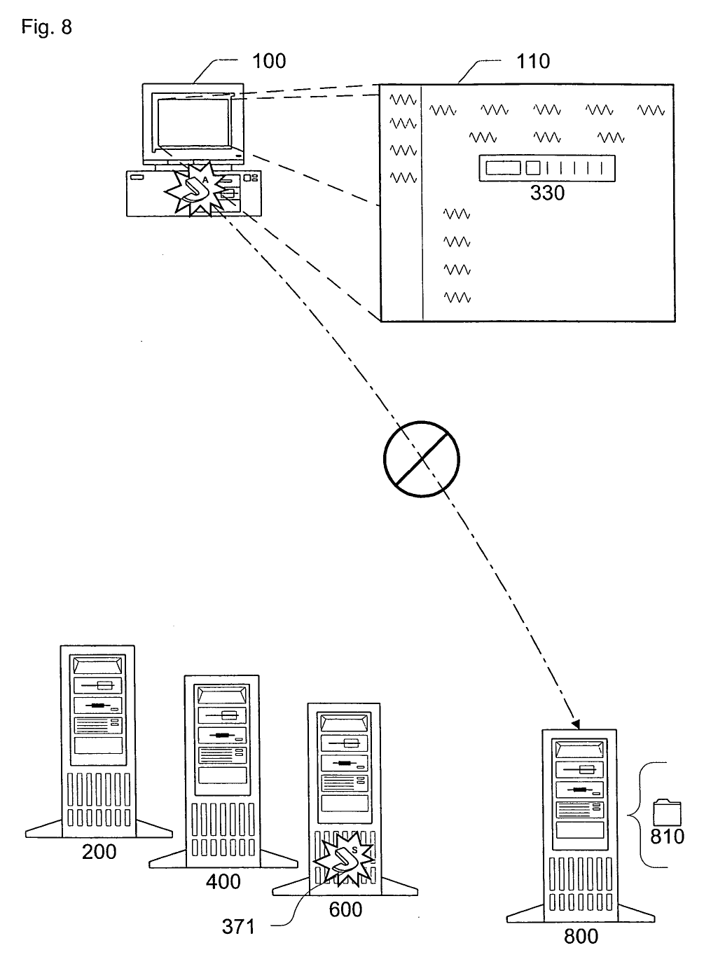

FIG. 8 shows an operation that is prevented by the security constraints of the Java sandbox. That is, when the interactive element 370 active at the web client 100 needs a file 810 located at a distant server 800, the web client 100 is prevented by the Java sandbox from requesting or receiving the file. Let it be assumed for the moment that the distant target file 810 includes advertising content needed to provide in the ad space 330 5 an interesting and interactive advertisement.

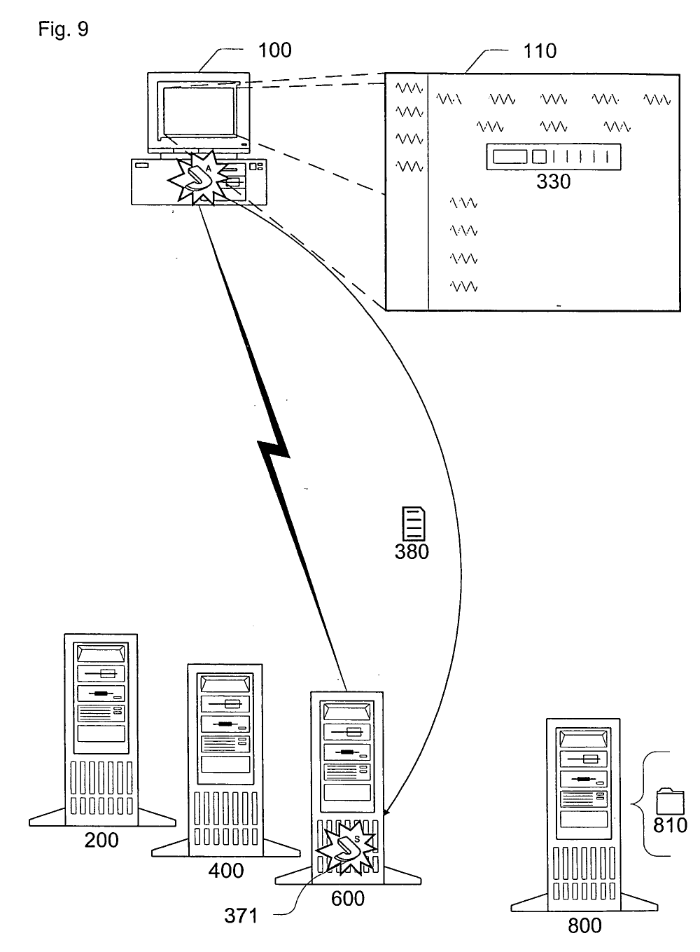

To overcome this problem, when the interactive element 370 at the web client 100 sends a distant file delivery request 380 (see FIG. 9), it sends the distant file delivery request 380 to the companion element 371 at lo the companion element address at the element server 600.

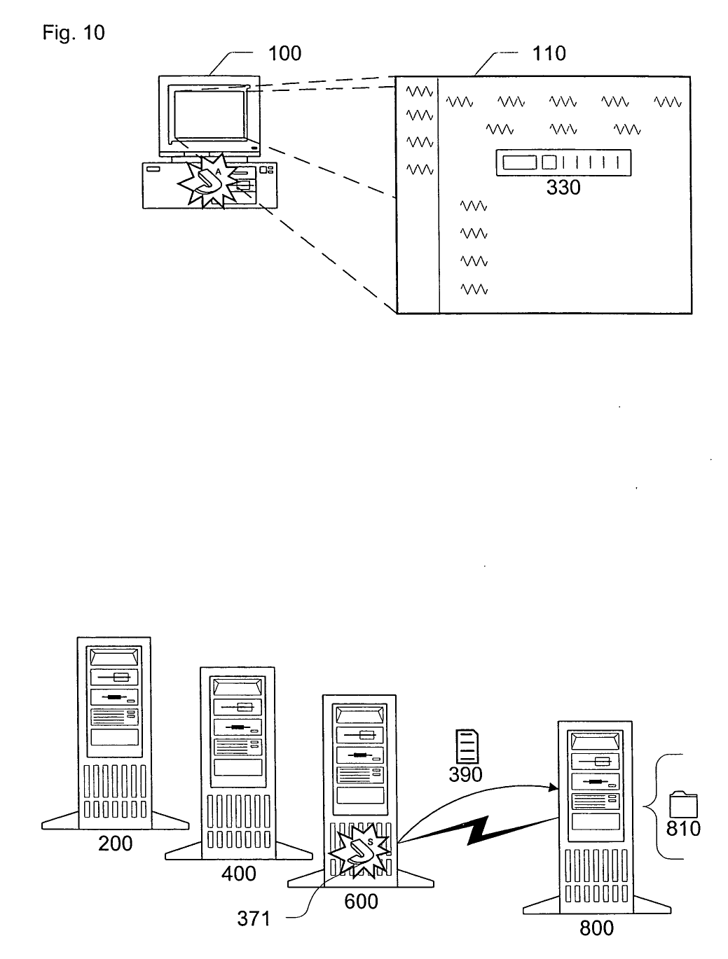

The distant file delivery request 380 sent to the companion element 371 includes the distant target file 810 address. The companion element 371 receives the distant file delivery request 380 and resolves the 1s distant target file address. The companion element sends a companion distant target file request 390 (see FIG. 10) to the distant target file address to obtain the distant target file 810, which may be any type of content. The companion distant target file request 390 may be an HTTP 20 get request. At the address is a distant server 800.

The distant server hosts the distant target file 810.

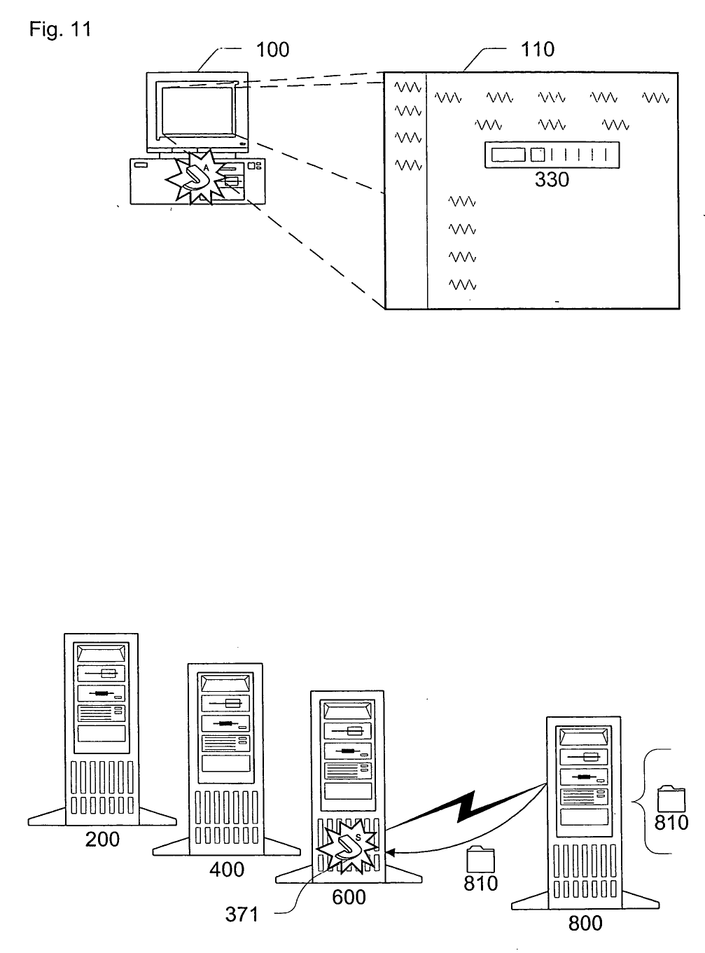

The distant server 800 responds to the companion distant target file request 390 by sending (see FIG. 11) the distant target file 810 to the companion element 371.

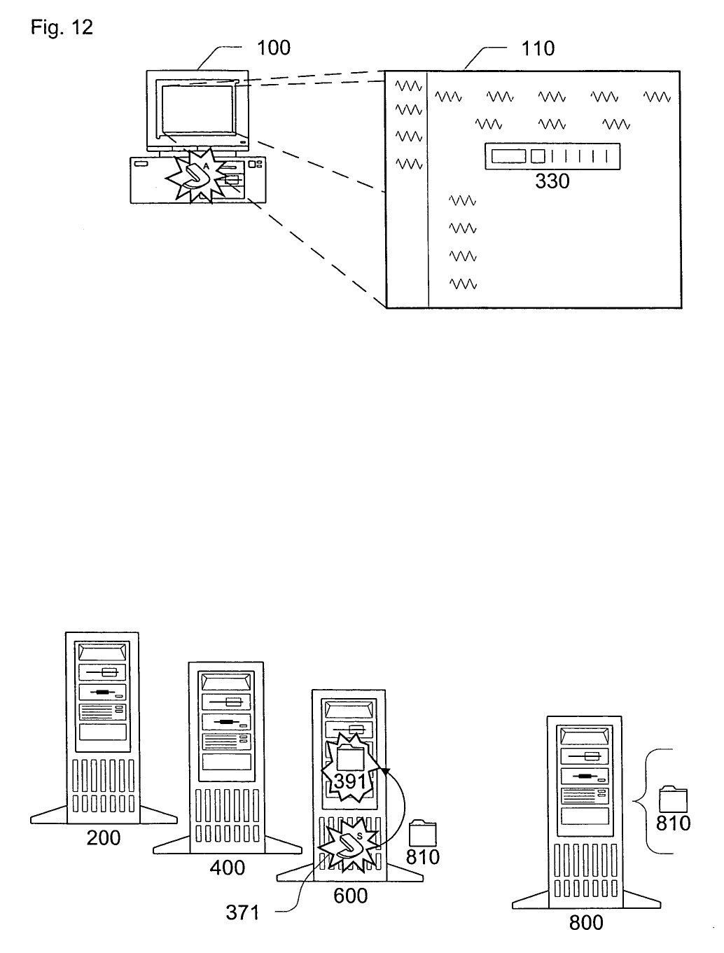

The companion element 371 receives the distant target file 810 and stores it (see FIG. 12) at the element server 600 as a local target file 391 corresponding to the distant target file 810. As mentioned already, storing the distant target file as a local target file includes storage on hard disk, in random access memory, in cache, or any other kind of memory.

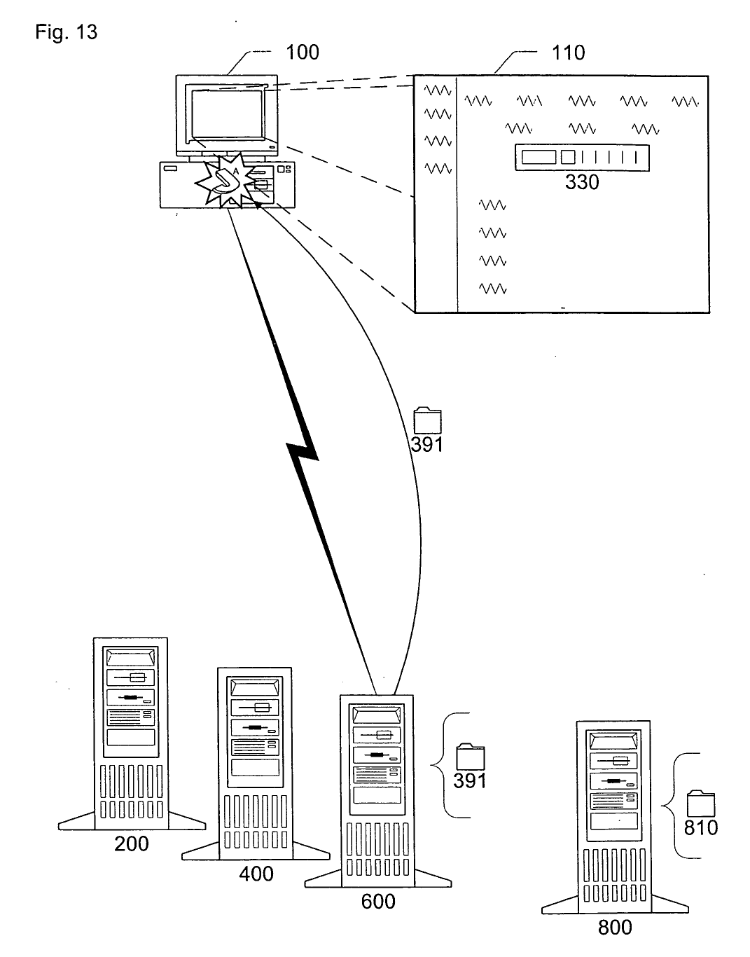

The companion element 371 causes the local target file 391 to be provided (see FIG. 13) to the interactive element 370 in satisfaction of the distant file delivery request 380. “Providing” as shown in the figure is a direct operation, but “providing” is not limited to just direct delivery. The file could be provided by other ways such as giving the interactive element an address at the element server at which to obtain the local target file. Other ways of providing the local target file to the interactive element will occur to those familiar with this field.

The interactive element 371 uses the local target file 391 as an input for displaying the ad space 330.

In this preferred embodiment, the companion element 371 is not an APPLET running on web client 100 and is not constrained by the security limitations of the Java sandbox (which do apply to the interactive element 370). The companion element 371 thus makes it possible for the interactive element 370 to obtain files from and to deliver files to a distant server 800.

Because files can be obtained from and delivered to a distant server, banner ads can be completely interactive, and can provide all of the functionality of a merchant site without the disadvantage of the browser being redirected to a page different from the primary web page.

The foregoing explanation relates specifically to the situation in which an interactive element is required to obtain a file from a distant server. This situation may be understood as a distant target file delivery operation. From the foregoing explanation, it can easily be understood that a substantially similar operation is undertaken when the interactive element is required to send a file that it has to a location at a distant server (i.e., to perform a distant target file transmit operation). That is, the interactive element sends a distant target file transmit request to the companion element, and the companion element handles the actual putting of the file to the address at the distant server.

Since the companion element sometimes gets a file from a distant target file address on a distant server (in a distant target file delivery operation) and sometimes puts a file in a distant target file address on a distant server (in a distant target file transmit operation), it may be said that the companion element in either case is interacting with the distant file server in accordance with the distant file request of the interactive element.

Also, it will be appreciated by one familiar with this field that the requirement of the interactive element to perform a distant target file receive operation or a distant target file transmit operation can come about by various circumstances. Such circumstances include user interactions with the interactive element, initial program loads, and the like. The phrase “a distant target file requirement of the interactive element”, when used herein, thus is meant to be inclusive of these various circumstances, and not limited only to user interactions.

To put in a concise way, the distant target file requirements of the interactive element result in distant file requests being sent to the companion element with an identification of a distant target file address, and the companion element responds by interacting with the distant server in accordance with the distant file requests.

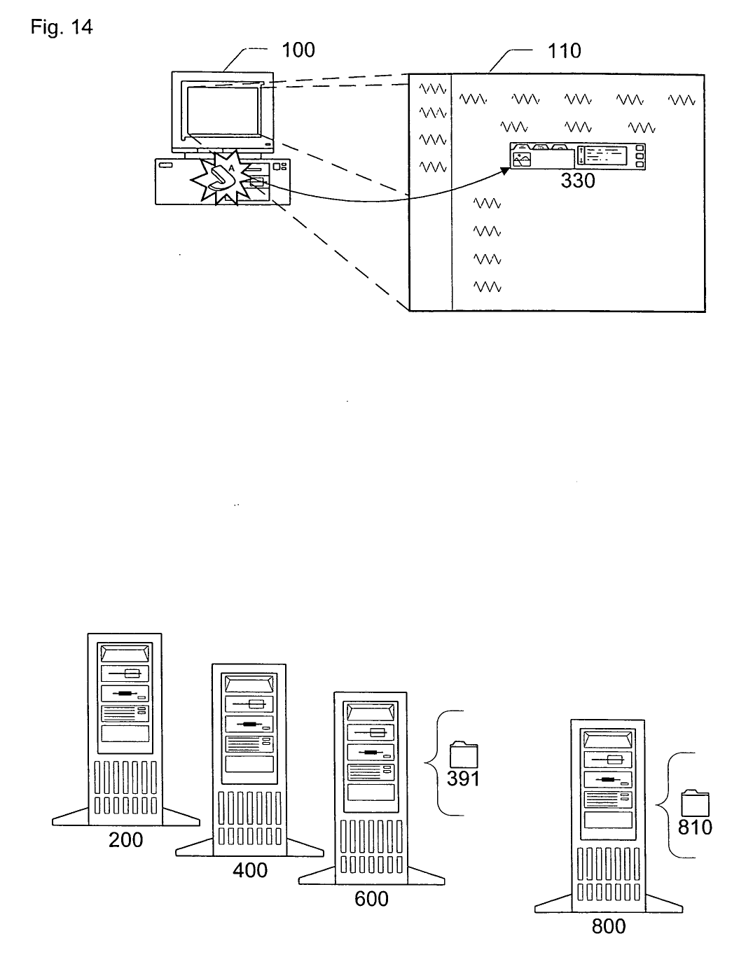

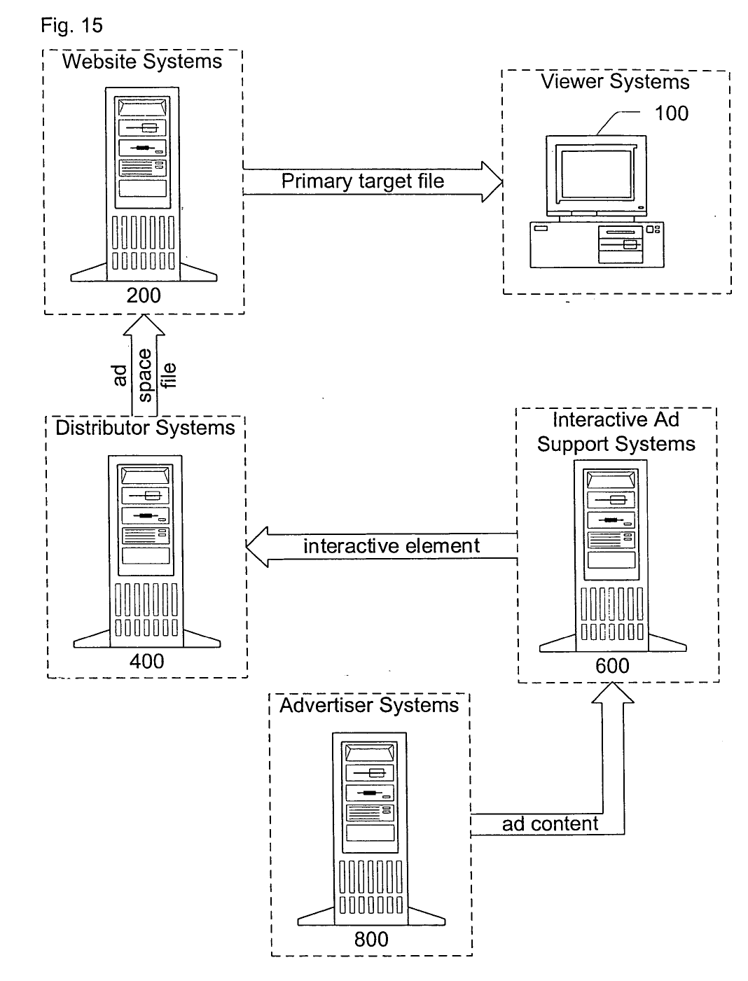

FIG. 15 provides a high-level overview of the process shown in FIGS. 1-14. In FIG. 15, the user's workstation and the web client 100 may be thought of as a viewer system. The primary web server 200 may be thought of as a website system for providing to a viewer system a primary target file. The primary target file provided from the website system 200 to the viewer system 100 includes a reference to an ad space file from a distributor system. The ad space server 400 may be thought of as just such a distributor system. The ad space file referenced in the primary target file includes a reference to an interactive element provided by the element server 600. The element server 600 may be thought of as an exemplary interactive ad support system. The interactive element provided by the interactive that support system may draw upon ad content provided by an advertiser system (also referred to as a vendor system), such as the server 800.

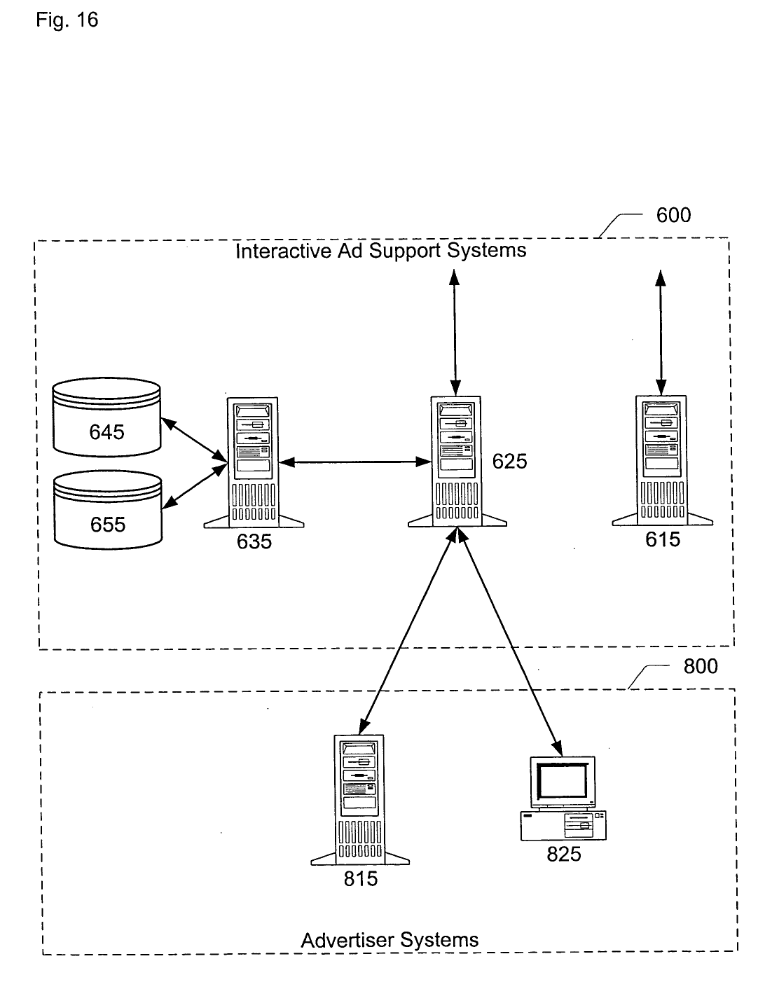

FIG. 16 shows another way in which the overall system of FIGS. 1-15 may be implemented. In FIG. 16, reference numeral 600 generally indicates the interactive ad support system. It is to be understood that the different servers shown within the interactive ad support systems could of course be implemented in the same or different physical computer systems.

Reference numeral 615 is an ad server for providing the advertising program (i.e., ad program) to the web client. The ad server is responsible for handling customization and environment related tasks and information, and determining context and bandwidth data. The ad server receives the interactive element request and responds with an interactive element target file.

Reference numeral 625 is a content server for responding to distant file requests by obtaining the corresponding files from distant servers or transmitting the corresponding files to distant servers. The content server may be thought of as corresponding to the companion element described above. As already mentioned, the content server is responsible for obtaining requested distant files from a distant file server, such as the advertiser systems 800. The content server may also provide functionality for allowing the advertiser periodically to update information about the ad content to be provided from the advertiser systems. Finally, the content server may collect viewer and tracking data, commerce data, and record interactions with respect to the user, and may provide such viewer, tracking, commerce, and content, and ad content updating data to the database server 635.

Reference numeral 635 is a database server, and is shown as interacting with databases 645 and 655. Database 645 represents a database for advertisement tracking, performance, and viewer data. Database 655 represents an ad content database. It will be appreciated, of course, that showing this information broken into two databases is merely for conceptual purposes. The data could be broken into many more databases, or could be consolidated into one. Moreover, each database could have its own separate database server.

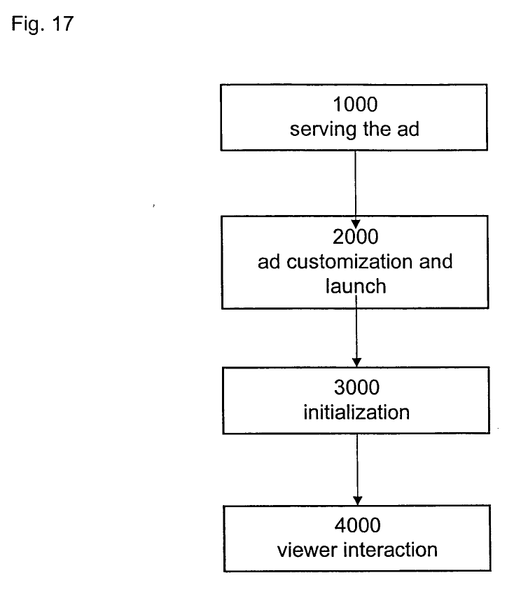

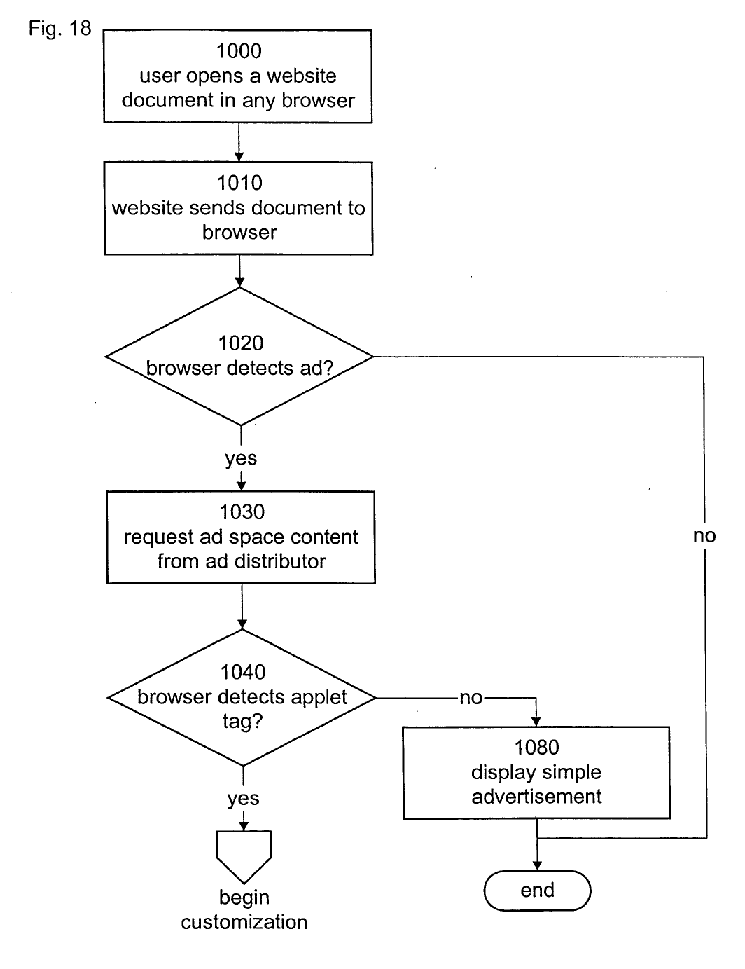

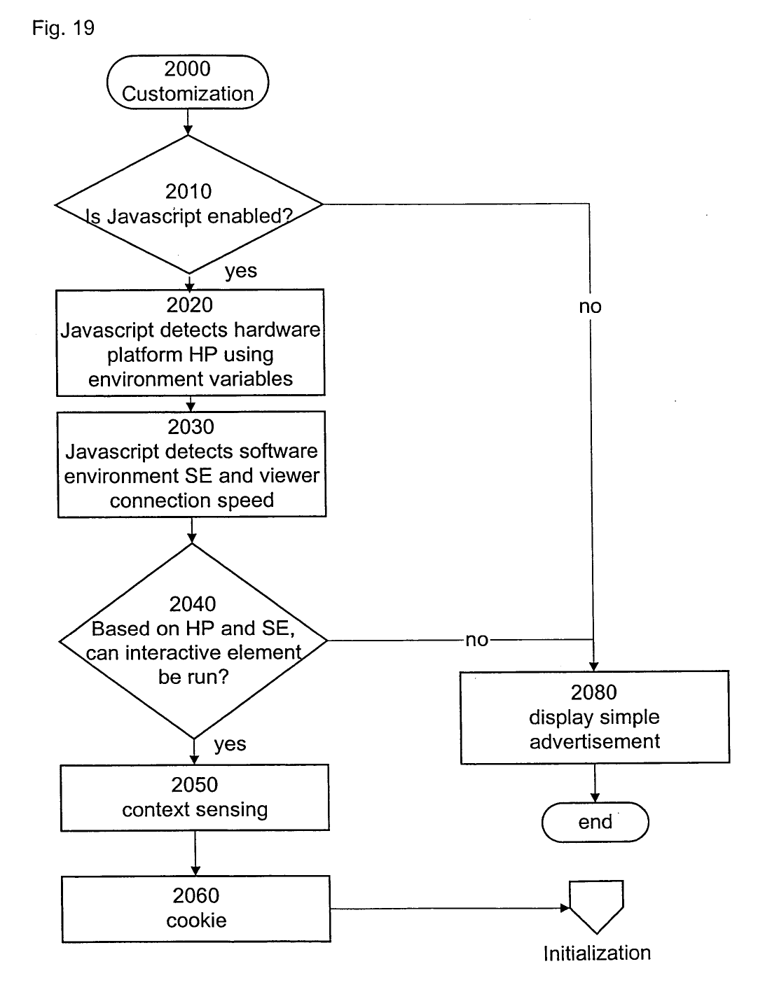

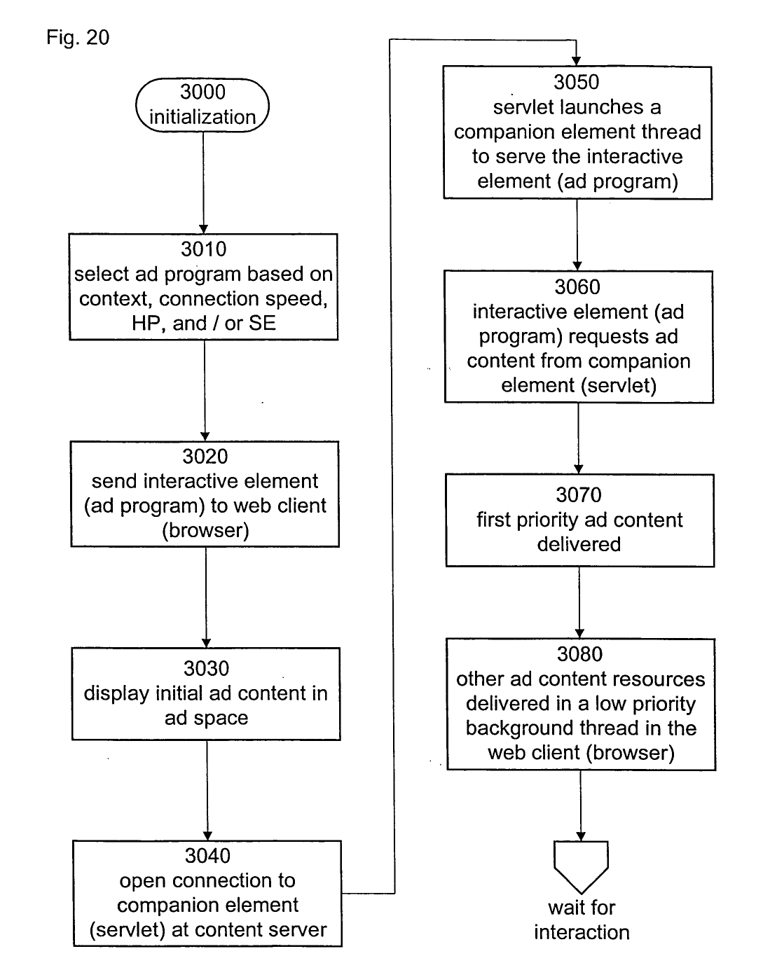

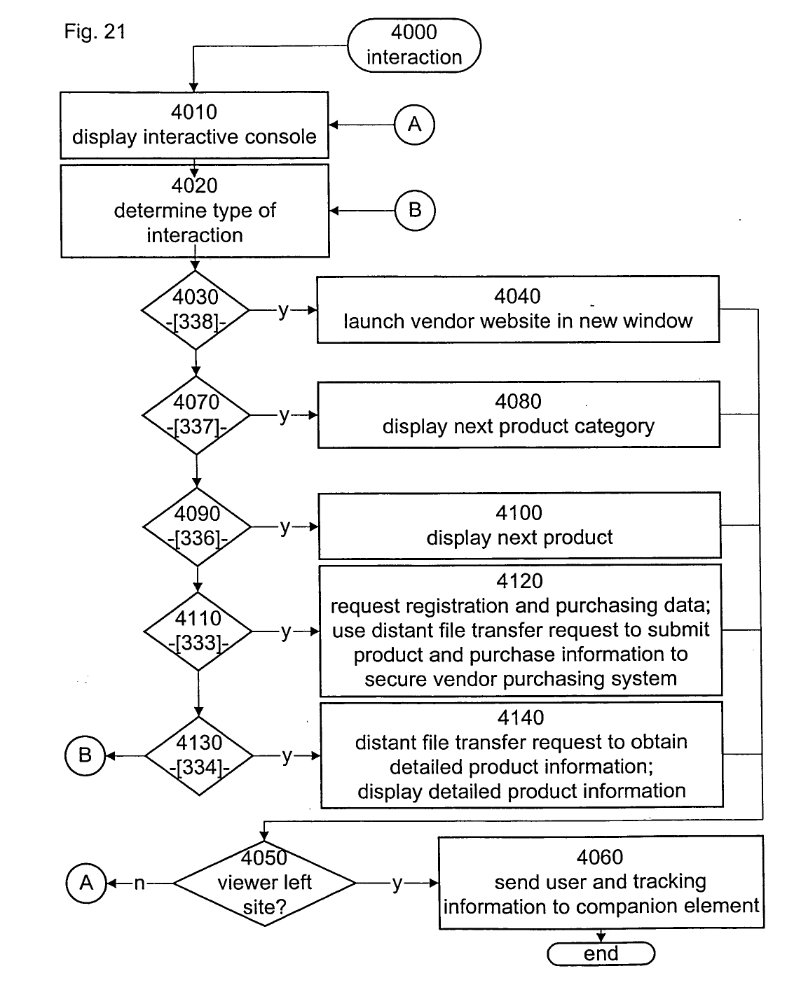

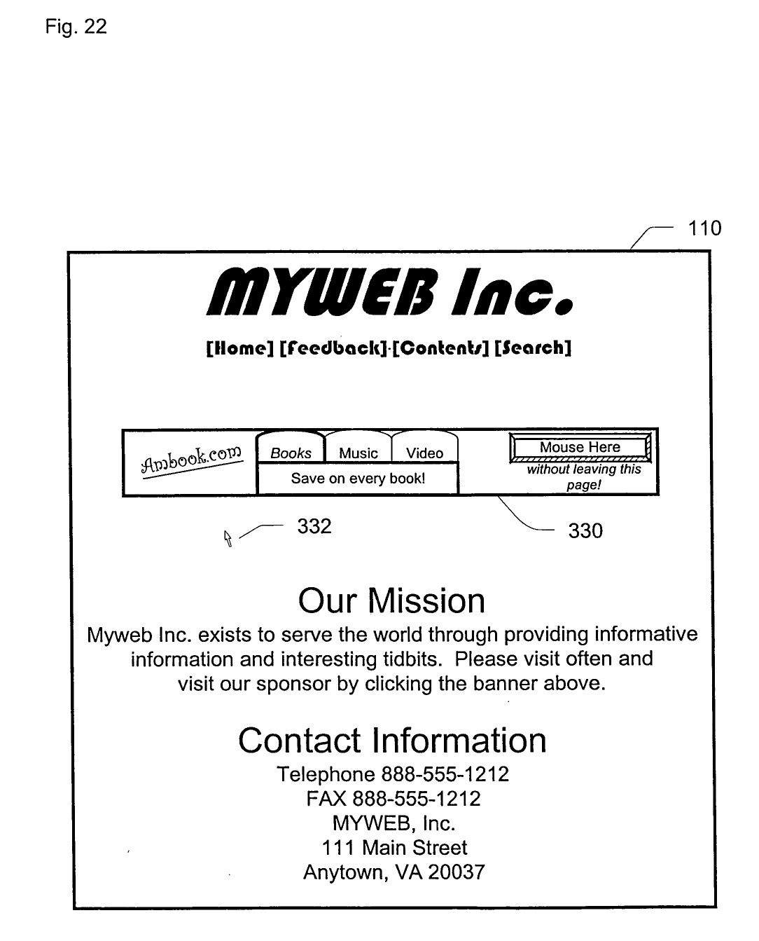

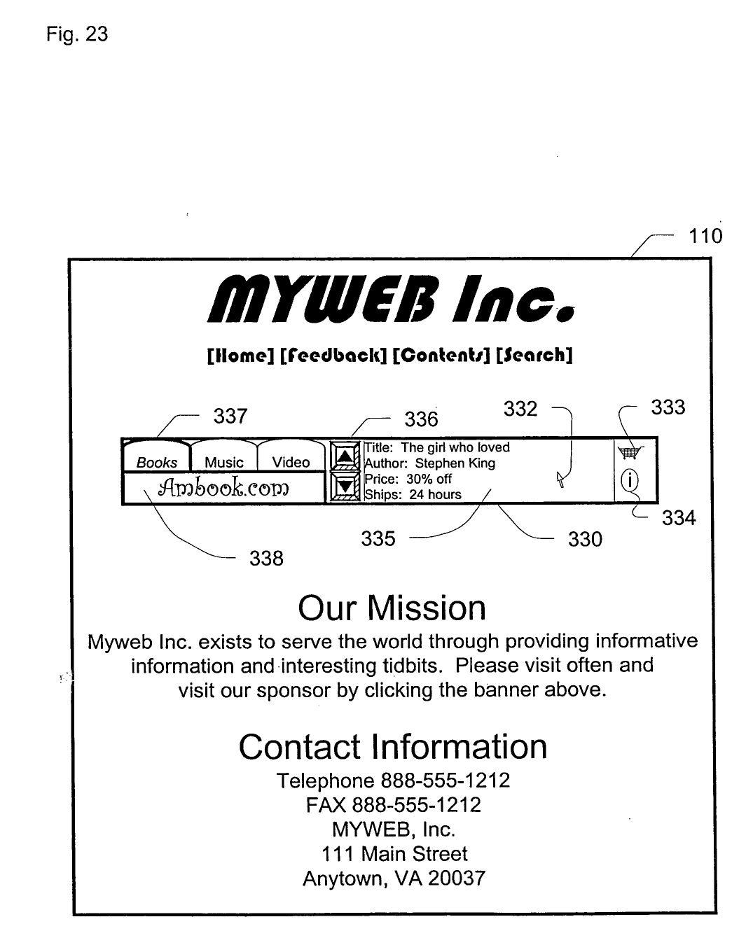

FIG. 17 shows an overall flow diagram that is useful in conceptually understanding the manner in which advertisements are delivered, customized, initialized, and used. In FIG. 17, step 1000 involves serving the advertisement. This step is described in more detail in FIG. 18. Step 2000 involves ad customization and launch, and is described in more detail in FIG. 19. Step 3000 involves initialization tasks, and is described in more detail in FIG. 20. Step 4000 involves viewer interaction, and is shown in more detail in FIG. 21. FIGS. 18-21 will be described in more detail after a brief explanation regarding FIGS. 22 and 23.

FIG. 22 shows a notional website, belonging to the my web company. The display 110 is produced by the web client 100. The display 110 includes an ad space 330. In FIG. 22, the reference numeral 332 indicates a mouse pointer. In the ad space is an initial display which may or may not be an animated GIF or the like.

FIG. 23 shows the same notional website, belonging to the same company, but now the cursor 332 has been moved over the ad space. This mouse over operation is an example of an interaction with the ad space 330. Other interactions are possible, such as a click or the like.

Upon detecting this first interaction, the ad program (i.e., the interactive element 370) responds in a predetermined fashion. In this preferred embodiment of the invention, the initial display shown in FIG. 22 changes, with the mouse over, to a display shown in FIG. 23. The display shown in FIG. 23 constitutes an interactive console. The interactive console includes various elements.

In FIG. 23, reference numeral 332 indicates the cursor, 333 indicates a user activatable area for a shopping cart operation. 334 indicates a user activatable area for obtaining detailed information about a product. Ref. 335 indicates a display area for showing general information about a product. Ref. 336 indicates a pair of scroll buttons, used to indicate to the ad program that the user wishes to view another product. Ref. 337 indicates a user activatable area used to indicate a category of products the user wishes to view. In the present illustration, the category indicator area shows that the present category is “books” by virtue of the fact that the text is the talus sized and the area around the “books” tab has a darker line. Ref. 338 indicates a link to the site of the advertiser.

With FIGS. 22 and 23 in mind, the description will not returned to FIG. 18. In FIG. 18, step 1000 is the first step in the process of serving the advertisement. In particular, the user opens a website document in any browser (i.e., sends a primary file request 310 to a primary web server 200). In step 1010, the website sends the requested document to the browser (i.e., the primary web server 200 sends the primary target file 320 to the web client 100).

In step 1020, if the browser detects that the primary target file 320 includes an ad space definition, the browser identifies the address for obtaining the ad space content and, in step 1030, requests the ad space content from the ad distributor (i.e., sends an ad space file request 340 relating to an ad space target file 350 to the ad space server or distributor system 400). If, on the other hand, there is no ad space definition in the primary target file 320, then processing comes to an end.

After step 1030, when the ad space target file 350 is received and the web client 100 begins to update the ad space 330 in the display 110 in accordance therewith, the browser may or may not detect in the ad space target file 350 an indication that an interactive element 370 is to be downloaded. If no such indication is present, processing continues with step 1080, in which a simple advertisement is displayed in a conventional manner. On the other hand, if there is an indication that an interactive element 370 is to be obtained, then processing continues with the customization step.

The customization step is shown in FIG. 19. In FIG. 19, a determination is made in step 2010 as to whether Java script is enabled. If Java script is not enabled, processing continues with step 2080 in which a simple advertisement is displayed. If, on the other hand, Java script is enabled, then processing continues with step 2020. In step 2020, a Java script is used to detect the hardware platform (HP) of the user's equipment. The Java script may use environmental variables to obtain this information is Java script may also be used to detect the software environment (SE) and viewer connection speed. This operation is shown as a step 2030. It will be appreciated, however, by one familiar with this field, that many of the steps shown in the flow diagrams could be performed in a different order. Steps 2020 and 2030 provide a good example of this. It is not greatly important to determine HP prior to determining SE. These steps could be performed in a different order, or in parallel if possible.

Different current examples of hardware platforms HP include IBM-compatible PCs, Apple Macintosh, Unix, or hand-held type platforms. Different current examples of software environment information SE include the operating system, the browser, the particular versions of each, the inventory of plug-ins, and whether or not Java is enabled.

In step 2040, a determination is made as to whether, based on the present HP and SE the desired interactive element 370 can be run. If the determination is in the negative, then processing continues with step 2080 and a simple advertisement is displayed. If the determination indicates that the interactive element 370 (i.e., the ad program) can be run in the ad space 330 then processing continues with step 2050.

In step 2050, context sensing is undertaken. Context sensing is used to determine the context of the page or circumstances in which the ad space is appearing. For example, if the HTML included in the primary target file 320 includes certain nouns or certain meta tags, the general context of the page can be determined. Based on the context of the page, it can be advantageous to select one type of interactive element for display over another. In other words, the selection of the interactive element may be based at least in part on the context information determined from the primary target file 320. The context could be obtained from other sources, such as the ad space target file 350.

In step 2060, a cookie operation is undertaken. If a cookie is already found on the viewer system, then the cookie can be used to obtain further context or customization data. If no cookie exists on the viewer system, then a cookie can be created. This is just another way to help customize the particular selection of the interactive element to have the highest potential for appeal to the user.

As part of steps 2050 and 2060, a determination can also be made as to whether the address of the viewer is already known, and whether there is address related information previously stored in the ad tracking database 645. Thus, the basis for the selection of a particular interactive element 370 may be based not only on context information, but also on cookie information or viewer address information. Processing then continues with the initialization step.

FIG. 20 shows the initialization step. In step 3010, the particular ad program is selected based on the context, connection speed, hardware platform, software environment, or the like.

In step 3020, the interactive element 370 is sent to the web client 100. In step 3030, the initial ad content such as that shown in FIG. 22 is displayed in the ad space. In step 3040, a connection with the companion element 371 is opened by sending a message from the interactive element 370. The companion element 371 is a multithreaded entity, and in step 3050 a companion element thread is launched to serve the particular instance of the interactive element 370. In step 3060, the interactive element 371 obtains the necessary ad content from the ad content server 625 of the interactive ad support system 600 (via the companion element).

It should be noted that there are different ways of performing the initialization step. The interactive element 370 could be programmed to directly obtain resources from the interactive at support system 600 when a determination indicates that the resources are actually local target files and not distant target files. The interactive element 370 could be programmed to obtain resources via the companion element 371 when a determination is made that the resources required are distant target files. Alternatively, the interactive element 370 could be programmed to obtain all resources via the companion element 371. In such a case, the companion element 371 would have the responsibility for making the determination as to whether the required resource is local to the interactive at support system 600 or is at a distant server 800 such as the advertiser system.

In step 3070, the first priority ad content is delivered. Certain ad content is delivered with a higher priority than other ad content based on the likelihood of the user needing immediately to view the information. In step 3080, other ad content resources are delivered to the interactive element in a low priority background thread in the web client 100. The ad space 330 might appear as that shown in FIG. 22. Processing continues on, when an interaction occurs, with the interaction step shown in FIG. 21.

Once an interaction of any kind is detected, such as a mouse over interaction, the interactive console is displayed at step 4010. The interactive console could be as shown in FIG. 23. FIG. 21 includes many specificities that are closely tied to the example shown in FIG. 23. It will be appreciated, however, by one familiar with this field, that the particular displays and interactions and predetermined steps involved in any particular ad space will depend on the requirements of advertisers and users for an interesting and helpful interactive ad space.

After the interactive console is displayed, the type of the interaction is determined at step 4020. At step 4030, if the type of interaction is an interaction for activating the user activatable area 338, then at step 4040 the vendor website is launched in a new window and processing continues on with step 4050. In step 4050, a determination is made as to whether the viewer has left the side at which the interactive element 370 is being displayed in the ad space 330. If the determination is in the affirmative, then, at step 4060, the user and tracking information is delivered to the companion element for eventual inclusion in the ad tracking database 645. On the other hand, if the viewer has not yet left the website, processing from step 4050 continues to step 4010.

Returning now to step 4070, if the interaction of the user is with one of the category tabs in the user activatable area 337, and processing continues with step 4080 in which a product from the selected product category is displayed.

When the interaction of the user is with one of the buttons in the user activatable area 336, then processing continues with step 4100, in which the next product within the present category is displayed.

When the interaction of the user is an interaction activating the user activatable area 333 representing a shopping cart, then processing continues with step 4120. The processing in step 4120 would include using the ad space to request registration and purchasing data from the user. The display shown in FIG. 23 would change so that, in the ad space, text entry fields would be provided so that the registration and purchasing data from the user could be collected in an appropriate form. Once this information collection was complete, the interactive element 370 could use a distant file transfer request to submit the product and purchase information to a secure purchasing system of the advertiser or vendor, such as the advertiser system 800. The distant file transfer request would be handled by the companion element 371, thereby avoiding the security restrictions of the Java sandbox.

When the user interaction is an interaction with the user activatable area 334, the interactive element is responsive thereto to send, in step 4140, a distant file transfer request to the companion element 371 to obtain detailed product information about the particular product displayed in the display region 335. This detailed product information might be available in the ad content database 655, but also might be available only from the distant server 800 comprising the advertiser system. The detailed product information for a book, for example, might include a critical review, a picture of the book, a brief audio recording from the author recommending the book, or an audiovisual presentation such as a commercial for the book. It is impractical to anticipate which users will want the detailed information for which books, and it takes a lot of resources to produce such information. Therefore, such detailed information would be impractical to download to the ad space 330 for every time any user was ever presented with the ad space 330.

By virtue of the existence of the companion element 371, the interactive element 370 can in directly obtain information from the entire information store of the advertiser. Likewise, the companion element makes it possible for information from the interactive element 370 to be provided outside the Java sandbox to distant servers such as a secure purchasing server for a vendor.

If the user action was not one of those predefined for the interactive element, processing after step 4130 continues on back to step 4020.

As step 4060 indicates, there is a function in the interactive element for recording user information and interactions. This information may be referred to as tracking information. The tracking information can be useful for vendors in creating a profile of a particular user.

The particular example shown in FIGS. 22 and 23, and diagram to in FIGS. 18-21 is for illustration only and is not meant in any way to limit the scope of the claims appended to this description. Further embodiments of the invention will now be discussed in less detail, with the understanding that the interaction between the interactive element and the companion element has been discussed in great detail and need not be repeated for each of the further embodiments. Additionally, is to be understood that, even though the further embodiments are numbered, the numbering is for convenience of reference only and is not meant to indicate any particular order of use or preference.

### 1. Interactive Goods and Services Presentation

The advertising program places the advertiser's entire selection of goods and services, or any portion of that selection or any other commerce offerings directly in the advertisement, allowing the viewer to browse through the full extent of an advertiser's products and services through the advertisement without leaving the original website or environment in which the ad was presented. For example, the top selling book inventory from a bookstore could be accessed through the advertising program, providing pictures, descriptions, prices, availability, reviews, samples, and any other purchasing information for any number of the top selling books from that bookstore.

### 1a. Transaction Enabled Advertisement

The advertising program gives the viewer access to the full transaction functionality of the advertiser's website, enabling purchases or any type of goods and services to be made including but not limited to purchases over the internet. Such transactions are made without making the viewer leave the original website or environment in which the ad was presented. This transaction functionality includes ‘shopping cart’ capability, allowing the viewer to select multiple products and then purchase them all at one time all within the confines of the advertising program.

### 1b. Viewer Cursor Interaction

The advertising program can begin by displaying any traditional advertising material such as images, animations, or text, but as soon as the viewer interacts with the advertisement in any way such as moving the cursor over the ad space, the advertising program reacts to that interaction and attempts to attract the attention of the viewer by changing its appearance, making a sound, flashing, beginning a secondary presentation or any other attempt to attract notice and prolong the viewer interaction with the ad. Once the advertising program begins to interact with the viewer, the viewer can select different content areas and functional responses by cursor selecting different active areas in the ad presentation. For example, such responsive active areas within the ad presentation can launch multimedia product samples, reviews, send the viewer to some other external resource, take the viewer through a hierarchy of screens and presentations, connect the viewer to purchasing fulfillment programs, launch any kind of external program, or connect to any other possible function in the ad presentation.

### 1c. Incremental Resource Loading

The advertising program minimizes the size of resources initially sent to the viewer for the fastest possible loading performance. After the ad is initialized and has loaded its highest priority resources, it begins loading remaining resources in a low priority background thread. In subsequent viewer interactions and requests, it loads resources on demand.

### 1d. Environment Detection and Bandwidth Sensitivity

The advertising program server detects the environment of the viewer even before loading any ad into the viewer's memory. It detects the viewer software and hardware environment and the connection speed between the advertising program server and the viewer itself, and decides whether to deliver simply an image or text, or to deliver the actual advertising program. Once the appropriate program for that viewer's environment is loaded, it can continue to detect the speed of the connection and can adapt the level of media complexity and bandwidth delivered accordingly.

### 1e. Advanced Platform Adaptation

The advertising program environment detection extends beyond the level described in 1d. The program also has an advanced platform detector that can determine if the viewer is viewing from a very high bandwidth environment, a very low bandwidth environment, a handheld computing platform, a wireless platform, an automobile platform, an advanced television interface, or any other specialized computing platform. The advertising program can adapt the presentation to meet the unique characteristics of that viewer environment.

### 1f. Context Sensitivity

The advertising program server determines the text context of the viewer even before loading any ad into the viewer's memory. It uses this contextual information to choose the most closely targeted ad available. After that ad is loaded, it can use that contextual data to customize the content of that ad presentation to most closely match the context of the ad's website environment. For example if the bookstore ad is displayed in a page that contains a text presentation about science fiction, the bookstore ad can display the top ten science fiction books.

### 2. Advertiser Emulation

The advertising program emulates the graphical appearance, branding, and look and feel of the advertiser's corporate image, color scheme, and web site graphics, giving the impression that the advertisement is actually an extension of the company's web site. This allows the advertisement to provide a sample of the advertiser's web site experience, improving the branding and consumer comfort and familiarity with the website. In the example from embodiment 1, the advertising program would incorporate logos, buttons, fonts, colors, images, writing style, and tabs that duplicate or emulate the bookstore website very closely.

### 3. Advertiser Functionality

The advertising program extends, includes, connects, or otherwise recreates any functions or interactive capabilities of the advertiser's website and services right in the advertisement space, allowing the advertiser to extend the services of the website through the advertisement directly to the viewers without requiring them to actually visit the website. In the example from embodiment 1, the advertising program would incorporate the bookstore's clickable tabs to select from different broad product areas just as in the bookstore website.

### 3a. Media Extension

In the case of advertisers from multimedia companies, the advertising program extends that multimedia functionality of the website through the advertisement directly to the viewers without requiring them to visit the advertiser's website. For example, in a streaming audio company the advertising program provides streaming audio channels to demonstrate the advertiser's audio products and services directly through the ad.

### 4. Advertiser Content Updating

The contents of any individual advertising program can be updated, removed, appended to, reorganized, and in any way changed by the advertiser at any time through a simple automated updating interface. This improves the advertisement by making it a dynamic product in which any and all aspects of the presentation and information contained therein can be changed by the customer at any time. In the example from embodiment 1, the top selling product catalog could be updated by the customer every day to present only the latest top selling products.

### 4a. Automatic Advertiser Content Updating

The advertising program has the ability to automatically update certain contents of any individual advertising program directly from the contents of the advertiser's website. The content to be updated is specially tagged and specified by the advertiser in accordance with the conventions of the advertising program. Corresponding content in the advertising program's presentation can then be recognized and updated automatically from the advertiser's website on a regular basis or at the advertiser's command.

### 5. Software and Digital Media Distribution

The advertising program is a distribution channel for any software products, written materials, all other media such as multimedia products, or any other type of product that is capable of being distributed directly through the internet medium. For example, if the company sells mp3 songs to be distributed through their website, the advertising program would allow the same mp3 song products to be distributed directly through the ad. As another example, if a company had a software utility or plug-in such as the RealPlayer audio player, that software product could be distributed to the viewer and immediately installed and executed, all right through the ad.

### 6. Viewer Registration and Subscriptions

The advertising program is a registration engine for gathering viewer subscriptions to and requests for goods, services and information. For example, the advertising program could be used to gather registration and billing information for subscription sales to magazines.

### 7. Customization to Individual Viewers

The advertising program can request or detect information about the viewer that is immediately used to customize the presentation to a target audience based on that viewer information. For example, the program can use such information to display targeted content areas from the website, from the advertiser's databases, from another program, from another server. It can customize its look, language, behavior, multimedia content, or any other characteristics and display information and messages based on the gathered viewer information.

### 7a. Customized Information Marketing

Viewer information can be used in coordination with the advertiser's databases or the advertiser's functional features to provide interactive information services such as quotes for customized goods or services.

### 7b. Customized Local Marketing

Viewer information can be used to target the content of the advertising program toward goods and services nearby the location of the viewer and offer incentives for the viewer to use those local goods and services.

### 7c. Customized Live Information Stream

This customized presentation can include information that is live or continually updated such as user selected news headlines, stock prices, election tallies or any other such time dependent information. This changing information can be updated and displayed at fixed intervals, or be updated live continuously as the information changes.

### 7d. Transaction-Enabled Customized Live Information Stream

This live information presentation can be combined with the transaction capabilities of the advertising program to create a dynamic purchasing system for time sensitive purchasing environments such as auctions or stock trades. The viewer is presented with live pertinent information as described above, and the ability to execute a transaction at any time based on that information. The advertising program also enables the viewer to set action targets on that changing information so that an alert or a transaction occurs automatically when a viewer defined condition is met in that information stream.

### 7e. Gaming and Transaction-Enabled Interactions

This live information with transaction capability described above can be extended to present a fully functional live gaming interface to the viewer. This gives the viewer access to ongoing games of chance in which the viewer registers and purchases the opportunity to play for winnings. The advertising program gathers customization preferences for the viewer's game entry, interacts with functional programs or servers at the advertiser's gambling website or server engine, displays the results of the game as soon as they are determined, then completes the transaction with the viewer based on those results.

### 8. Repeat Viewer Interactions

The advertising program can store customization information such as that gathered in embodiment 7 in a database for future reference and for use in customization for future contact with that individual viewer. This enables ads to be custom targeted to repeat viewers with no further information input required from them. This is an improvement over traditional ad interactions, which have not had or have not used access to stored viewer data. For example, such information can be stored in a viewer ‘cookie’, or the viewer computer address can be detected and stored viewer information can be retrieved based on that address.

### 8a. Voluntary Advertisement Targeting Service

As described in embodiment 8, the advertising program can detect or request detailed information from the viewer regarding any type of viewer preferences, customization information, or any other demographics, and can store that information in a database in such a way that it can be associated with that particular viewer in subsequent interactions either through the use of cookies, the viewer's address, or any other viewer identification technique. This customization, targeting, and viewer identification data can then be made available for general use in ad targeting and customization to individual viewers for any type of online advertisement in any setting including but not limited to advertisements that use the advertising program described herein.

### 9. Consumer Database Targeting

The advertising program includes any advertisements that can actively access and use data from any kind of consumer database. It can retrieve information from and add information to a large consumer database that contains detailed information about both general and individual consumer spending history, preference, habits and assets, and any other pertinent data. It can combine this data with specific knowledge of the viewer obtained directly from the viewer. The combination of these two sources of viewer information enables very precise viewer targeting and ad customization and powerful statistical analysis after the viewer interaction is completed.

### 10. Universal User Registration

The advertising program can store a comprehensive ‘universal’ user registration database including shipping and purchasing information as well as any other pertinent viewer information for use with any advertiser that uses the system. This obviates the need for the viewer to repeatedly enter any such information for repeat purchases with the same advertiser or for any purchase on any advertiser using the system. This enables faster and more convenient viewer interactions with the advertising program for any and all advertisers in the system.

### 11. Persistence in an Independent Environment

The advertising program has the capability to remove itself from the original ad space and to remain independently active and ‘alive’ outside of its original environment. This enables the viewer to elect for the ad to remain active without disturbing his or her original activities and environment, and enables the viewer to leave the website originally containing the advertisement without also leaving the advertising program.

### 12. Customized Functional Collective Environment, or “Portal”

One or more such advertising programs as have been described herein can be gathered together in a collective environment, such as in a ‘portal’ website. Such a collective environment could be customized by the viewer to contain any number and variety of advertising programs from any available advertisers in any desired arrangement in that environment. This would allow the viewer to create a customized portal environment gathering all the functionality, look and feel, interactive products and services, product catalogs, and any other features of the advertising programs from any and all available advertisers in the system together in one place based on the viewer's personal preferences.

### 12b. Third Party Collective Environment

One or more such advertising programs as have been described herein can be added temporarily or permanently as a feature to add functionality and commerce access to any third party interactive digital environment or website. Such a third party environment could also allow a viewer customization and layout as described in 12.

### 13. Opt-In Multimedia Presentations

The advertising program can deliver a viewer requested or ‘opt-in’ multimedia presentation to the viewer that is effectively the same as a traditional radio or television advertisement in which an audio, video or other multimedia presentation is presented to the viewer through the ad space upon viewer request.

### 13a. Interactive Multimedia Presentation

This multimedia presentation uses the interactive capabilities of the advertising program, enabling the viewer to control the presentation by interacting with it. The multimedia presentation allows viewer responses, behaviors, or selections to determine what subsequent multimedia presentations are presented, creating a unique interactive multimedia marketing presentation that can be different for every viewer and that tailors itself based on viewer responses.

### 13b. Interactive and Transaction Enabled Multimedia Presentation

This multimedia presentation uses the interactive and transaction capabilities of the advertising program, enhancing any or all presentation elements with background product information, separate marketing presentations, and/or transaction capability on that individual element. In such a presentation, the viewer can request and receive further information about any element in the presentation. This can occur either in an immediate response through the advertising program presentation, or in a subsequent marketing interaction through some other channel, such as through email. The viewer can elect to purchase the products represented by any or all elements in the presentation directly through the ad.

### 14. Viewer Surveys and Sales Leads

The advertising program can present a questionnaire or survey to gather viewer feedback regarding the plans, products, image, or any other pertinent information about the advertiser's business without requiring the viewer to leave his or her prior activities. Similarly, the program can generate sales leads for the advertiser to send follow up information and marketing to interested viewers, while minimally inconveniencing the viewer. Viewer contact information can then be used to send other forms of advertising and direct marketing opportunities to that viewer such as through email, telephone calls, faxes, standard ground mail, or any other form of communication.

### 15. Novel Consumer Profile

The advertising program uses a variety of information profiles such as those described herein and constructs from them a novel consumer/viewer profile that determines what advertiser presentation to display, and customizes the actual content of that presentation. This new consumer/viewer profile includes, but is not limited to, connection bandwidth, hardware address, hardware platform, software environment, operating system, ‘cookie’ data, data acquired from previous interactions, recent browsing history, referring website, current website context, purchasing history, standard demographic data such as address, age, country, language, and sex, data gathered in viewer surveys, data from consumer databases as described herein, and selections made by the viewer within the advertising program.

### 16. Post Presentation Marketing

The advertising program can present coupons, discounts, or other incentives during or after the advertising presentation to attempt additional marketing to the viewer, or to draw the viewer into the advertiser's website or business after the advertising interaction is completed.

### 17. Post Presentation Statistics and Tracking

When the environment containing the advertising program is left by the viewer, the program collects an array of information and statistics about the viewer's environment, behavior, interactions and their duration, interests, purchases and any other pertinent information and sends this information to the advertising server where it is added to a database for subsequent statistical analysis. This provides invaluable data about viewer response to the advertiser as well as about the effectiveness of the advertising program.

### 18. Communication Enabled Presentation

The advertising program can present a viewer communication interface between the advertiser and the viewer through the ad space.

### 18a. Natural Language Interface

The advertising communication interface could take the form of a natural language capable query program, similar to the www.ask.com search engine. In this embodiment, the advertising program would enable the viewer to ask questions, search through advertiser information, and learn about the products, services, identity, and any other pertinent advertiser information through the use of natural language based inquiries all within the confines of the ad space.

### 18b. Conversation Capable Agent Interface

The advertising communication interface could take the form of a ‘chatter bot’ or a ‘knowledge bot’, a program designed to interact in a text based conversation about a particular subject matter in a way that convincingly emulates interaction with another human being. This would enable a more interactive and engaging presentation to the ad viewer, and would allow the viewer to learn more about the products, services, identity, and any other pertinent advertiser information using natural language in an ongoing entertaining conversation-like manner all within the confines of the ad space.

This kind of agent technology is in development by companies like www.bicscience.com, but has not been applied to the advertising industry.

### 18c. Chat or ‘Instant Message’ Interface

The advertising communication interface could take the form of a ‘chat’ capability, in which an actual human representative of the advertising company would be available to have a direct conversation with the ad viewer through the ad space. The viewer could learn about the products, services, identity, and any other pertinent advertiser information in an actual ‘chat’ session with a live human being in an engaging entertaining and informative conversation within the confines of the ad space.

This kind of chat has been applied to customer service by such companies as www.facetime.net, but has not been applied to the advertising industry.

### Second Preferred Embodiment

A second preferred embodiment of the invention resides in an ad program having a context sensitive feature. Such a program may be referred to as a Context Sensitive Advertising Program.

The Context Sensitive Advertising Program enables any website publisher to associate very closely targeted advertisements with specific portions of their online content. The program can associate any specific words, topics, images, portions of images, or sections of any kind of content in a web page or other online presentation with special keywords that specifically refer to the subject matter of that content. Each of these keywords is matched by the Program with a closely targeted advertisement appropriate for that keyword When such a word, topic, or section has been specified by the webpage publisher as a context sensitive keyword, it is marked as such through the use of font, color, sounds, associated images, cursor changes, or any other kind of indicator such that the viewer of the webpage can easily tell that there is a distinction to that word, topic, or section that differentiates it from its surrounding content.

When the viewer interacts with the indicated content in any way, for example by lingering the cursor over the indicated content, or by clicking on the indicated content, the advertising program responds by interpreting that particular keyword, communicating the keyword to our Context Sensitive Ad Servers, and retrieving and displaying an ad presentation that is closely associated with the keyword in question. The ad presentation does not appear until the viewer has shown an interest in a particular keyword. When it does appear, it is shown in a special presentation area, for instance in a new window that appears at that time. If the viewer shows interest in the advertising presentation, for instance by placing the cursor on the presentation, the program detects this and keeps the presentation open for further viewer interaction. If the viewer does not show any interest in this advertisement presentation, the program detects this and politely closes the presentation after a certain period of time.

This program offers webpage publishers the opportunity to take advantage of their online traffic and generate revenue from their specialized content by using a convenient and unobtrusive targeted advertising system that does not require them to find the many vendors that would offer the advertising and product sales that matches their content. This program offers online advertisers the opportunity to reach a very targeted audience with their advertising message without invading the privacy of their viewers and does not require them to find and establish relationships with individual web publishers that have content that relates to their products and services.

Through use of this program, online advertisers may know precisely what a viewer is reading about at a particular moment, and may immediately present an appropriate targeted advertisement to that viewer. This enables very precise viewer targeting without any specific knowledge about the viewer, eliminating the need to invade the viewer's privacy in the interest of advertisement targeting. It also enables website publishers to generate revenue through advertising without cluttering their websites with banners and graphics that are unrelated to their webpage.

This is a great improvement over traditional banner advertising which is immediately displayed in an intrusive manner, and which is often not targeted to the context of the associated web page. This is a great improvement over existing ad targeting methods because the ad presentation that is displayed can be chosen based on a very specific keyword that is the exact subject of the viewer's attention at exactly that moment.

This is also an improvement over traditional targeting methods which attempt to determine the general topic area of a webpage and display ads associated with that topic, or they build a detailed profile of the viewer in question raising many concerns about the privacy of viewers of the webpage in question.

An exemplary implementation of a context sensitive advertising program will now be described.

The publisher of an online presentation enables their webpage to use the context sensitive advertising program by including HTML tags in the headers that will load an ad program from the interactive advertising support servers when that webpage is loaded into a viewer's browser. This program controls the placement of keywords within the presentation, controls communication with the context sensitive ad servers, and controls the advertisement presentation windows. The publisher then inserts simple HTML tags into the body of the webpage document that tell the ad program where in the presentation the content is to be enabled with a keyword targeted advertisement, and what specific keyword is to be associated with that particular content. These keyword tags communicate with the in-webpage Program which in turn communicates with the server side Program. The server side Program manages the database of keywords and advertising messages, communicates with the participating webpages in the network, reads the keyword from them, determines what is the most appropriate advertising message to display and communicates that message back to the Program in the webpage for display. The tags that enable the context sensitive advertising program can be inserted into online content in many ways, but there are two preferred methods. The first is for the web publisher to manually edit the HTML document for the webpage to be enabled, hand picking the keywords that will be enabled and placing the appropriate tags for that position and keyword. The second is for the web publisher to put an HTML document through a filter program which parses the HTML document for appropriate words and then automatically generates a new HTML document with the appropriate tags included.

A particular method of implementing the context sensitive advertising program will now be described.

The primary target page (e.g., http://www.mysite.com/commercials.html) includes a reference to a JavaScript function definition file (e.g., http://www.mysite.com/cc_imagepop.js). The JavaScript function definition file constitutes an ad program, and may include function definitions controlling context sensitive displays. In the present example, the ad program includes the function definitions of:
cca(n)—Commercialized Content Array;
ccp( )—Commercialized Content PopUp;
cct( )—Commercialized Content Timer;
ccu( )—Commercialized Content UNDO Timer; and
cki(insertiontext, keyword)—Commercialized Keyword Insert.

These will be discussed in more detail below. The HTML of the primary target page could include a statement like the following:

<p>We like the new <script>cki(‘Roadeater
320’,‘bike’)</script>, the <script>cki(‘Compufast 800
Mhz’,‘comp800’)</script>, and the great new
<script>cki(‘hula-hoop Hawaiian
shirt’,‘hulashirt’)</script>. You will, too!.</p>

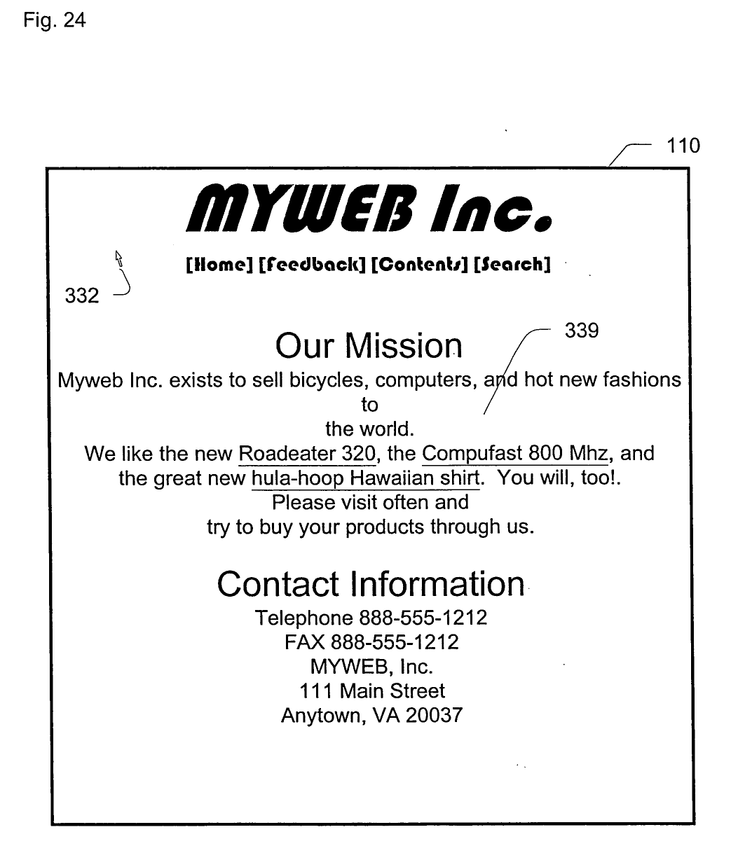

When this primary target page is displayed by web client 100 in a display 110, the result could be like that shown in FIG. 24 (see reference numeral 339). In FIG. 24, there is also shown a mouse pointer 332.

The <p> tag indicates a paragraph, and the </p> tag indicates the paragraph's end. The <!-- . . . → pair of tags indicate comments. What adds the useful functionality is the <script> . . . </script> pairs of tags. The purpose of this page is to sell the products, but here the context would be difficult or impossible for a machine to determine because the page appears to relate to bicycles, computers, and fashions. Consider the notional Compufast 800 computer. Using a typical banner ad would have a low likelihood that the banner selected by the ad distributor for display would relate closely to the products to be sold.

The web page author can, however, simply use the cki function (to be described below) to link the particular text (Compufast 800 Mhz) with a predetermined keyword (comp800) and leave the interactive advertising server support systems to provide a targeted ad from a vendor selling the product.

For the remainder of the example, the Compufast 800 Mhz computer will exclusively be discussed to avoid obscuring the explanation with too much detail.

The script tags indicate to the web client 100 that script statements are included. The only script statement is the function call:
cki(‘Compufast 800 Mhz’,‘comp800’)
This is what the author of the Web page must do to make parts of the page into context sensitive advertisements. The part that will appear in the page is “Compufast 800 Mhz,” the name of a computer. The part that is used by the interactive advertising support systems is the keyword “comp800”. Any of a variety of words could be used. The words are predetermined in the interactive advertising support systems.

The function call to cki passes the value of ‘Compufast 800 Mhz’ as the parameter ‘insertiontext’, and the value of ‘comp800’ as the parameter ‘keyword’. The cki function may be as follows:

```
function cki(insertiontext, keyword)
  {
  launchString =
      ‘<a href=\‘javascript:ccp( );\’
      onMouseOut=\“ccu( );\”;
      onMouseOver=\“key=\‘’ + keyword +
      ‘\’;cct( );\”>’ + insertiontext +
      ‘</a>’;
  document.write(launchString);
}
```

The document.write statement causes the HTML to include as HTML the contents of the variable launchString.

The result of the function call to cki is a change to the HTML of the primary target page from that shown above to:

```
<p>We like the new ... , the <a href=‘javascript:ccp( );’
    onMouseOut=“ccu( );”
    onMouseOver=“key=‘comp800’;cct( );”>
    Compufast 800 Mhz
    </a>;
, and the great new ... .  You will, too!.</p>
```

The function cki thus defines in the primary target page an anchor tag around the words “Compufast 800 Mhz”. When the link is clicked, the ccp( ) function is called. When the onMouseOver event is detected, the cct( ) function is called, and when the onMouseOut event is detected, the ccu( ) event is called. The value for “key” is not assigned until the onMouseover event is detected, at which time the cct( ) function is called.

The ccp( ) function may be as follows:

```
function ccp( )
    {
    this.cckey = new cca(key);
    var destination =
        ‘http://www.mysite.com/ccwindow.html’;  var
config = ‘... width=‘+xdim+’, height=‘+ydim+’, ... ;
    this.popwinname =
        window.open(destination,‘pup’,config);
    if(popwinname.opener == null){
        popwinname.opener = self;}
    }
```

The ccp( ) function call from the cki( ) function call causes a popup window (i.e., an ad space) to be positioned in accordance with the config information of the ccp( ) function, and the source for the popup window, which may be referred to as a popup target file or an ad space target file, is http://www.mysite.com/ccwindow.html.

It should be noted that the “cckey” value is based on the “key” value provided as a result of the onMouseOver event being detected with respect to the anchor at “Compufast 800 Mhz” in the text.

The popup target file may contain HTML source code such as the following:

```
<script>
var keyword = window.opener.cckey.val;
var bodyString=
‘<a href = \“http://www.mysite.com/KeywordRedirect?key=’
+ keyword + ‘\”> <img src =
\“http://www.mysite com/KeywordMgt?key=’ + keyword
+‘></a>’;
var closetimerID;
function cw( )
    {closetimerID = setTimeout(“self.close( )”, 5000);}
function cc( ){clearTimeout(closetimerID);}
self.focus( );
// End -->
</script></head>
<body
    onLoad=“cw( );”
    onMouseOut=“cw( );”
    onMouseOver=“cc( );”>
<script>document.write(bodystring);</script>
```

The result of the scripting commands in the HTML file of the popup target file is to write the HTML in the body using the contents of the variable ‘bodystring’. The bodystring for the popup, by virtue of the keyword passed from the primary target page is:

<a
ref=“http://www.mysite.com/KeywordRedirect?key=comp800”>
<img src=“http://www.mysite.com/KeywordMgt?key=comp800”>
</a>

That is, the popup target file (i.e., the ad space target file) includes an anchor <a>tag that redirects to a location defined by the ref=parameter, and the link is with respect to an image sourced according to the src=parameter. To put it another way, the popup target file includes an indicator of something to be loaded into the ad space. The “something” may be an interactive element or a static advertising display. Since interactive elements have been completely discussed with respect to the first preferred embodiment, it will-be assumed that the content is simply a static image.

The popup dismisses by itself after five seconds in the above example, unless an onMouseOver event is detected for the popup, in which case the popup stays active as long as the event remains. Of course, a click of the popup image will result in redirection to the popup link target location.

For the sake of completeness, the cct( ) function may be:
function cct( ) {opentimerID=setTimeout (“ccp( )”,500);} and the ccu( ) function may be:
function ccu( ) {clearTimeout(opentimerID);} or the like.

It will be appreciated that the image automatically displayed could be in a display other than a popup window. That is, the display could be embedded in the primary target page. The display could also be as part of a persistent banner commonly used by providers of free Internet access.

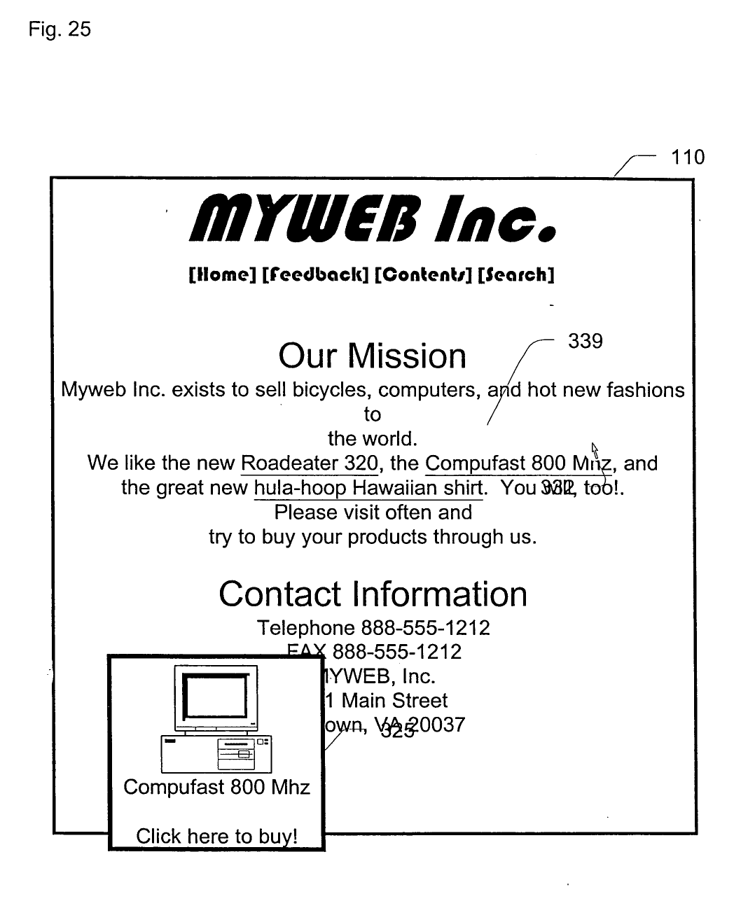

FIG. 25 shows the mouse pointer 332 lingering over a context sensitive area 339, and a corresponding display 325 appearing. The corresponding display 325 is an ad space. The corresponding display 325 is related to the context sensitive area 339 by a key-based function (namely, function cki in this example). Preferably, the corresponding display 325 appears in response to an onMouseOver event with respect to the context sensitive area 339, but other user interactions may trigger the corresponding display. Even more preferably, the corresponding display 325 does not appear unless the user interaction such as a mouse over has a minimum duration of at least a predetermined period, such as half of a second. In the preferred embodiment, the corresponding display 325 terminates itself after a predetermined duration of, e.g., 5 seconds.

The location of the corresponding display may vary with each context sensitive area 339, or may be constant.

It will be understood that the predetermined relation between a key (in this example, a keyword, but numeric keys would work the same) and a particular display may be maintained in a database at the interactive ad support systems, such as the ad content database 655. The relation may be a simple relation between keywords and corresponding addresses. That is, in the present example, the ad content database 655 may include a table such as:

| Key | KeywordMgt | KeywordRedirect |
|---|---|---|
| mp800 | http://COMPFAST.com/ | https://COMPFAST.com/ |
| | c800.jpg | buy.html |

The entry under KeywordMgt indicates the location for the display for the ad space. This may be referred to as an ad space display management file. The entry under the KeywordRedirect indicates the location, if any, to which the browser will be redirected in the event of a user click in the ad space. This entry may be thought of as an ad space redirect address.

Thus, in the context sensitive advertising system, the primary target file contains a reference to an ad program. The ad program is a function definition file. The primary target file also contains a relation between each context sensitive display element and a corresponding key.

A user interaction with the context sensitive display area, such as a mouse over of the context sensitive display area, causes an ad space to be displayed according to the content of an ad space target file. It should be noted that, when the display of the ad space is in a separate display area, such as a popup window, it takes a user interaction with a context sensitive display area to cause the display of the ad space.

The ad space target file includes selection statements resulting in the selection of an ad space display management file based on the key related to the context sensitive display element. The ad space is displayed in accordance with the ad space display management file. When the statements in the ad space target file require that a file (such as an ad space display management file) from a distant server be obtained, a file request message is sent to a companion element at the interactive ad support system as in the first preferred embodiment, above.

The ad is displayed in the ad space in accordance with the contents of the ad space display management file.

Further embodiments of this second preferred embodiment of the invention will now be discussed. Again, even though the further embodiments are numbered, the numbering is for convenience of reference only and is not meant to indicate any particular order of use or preference.

### 1. Premium Affiliate Network

A further embodiment of this second preferred embodiment is realized in a premium affiliate network.

In this further embodiment, the collection of keywords, associated products for sale, and advertising presentations used by the Context Sensitive Advertising Program are built for the needs of one specific vendor or online business. A network of ‘premium affiliate’ webpages is enabled to use the Program with their online presentation content. These webpages use the collection of keywords from the one vendor and associate the appropriate words and sections of their content with Program keyword tags. When a viewer selects an indicated keyword, a targeted advertisement for a product offered by the one vendor is displayed. If the viewer is interested in that product, they may purchase it or pursue further information about it. The vendor benefits by getting great reach for its sales and product promotions in a dedicated network of targeted sales-enabled affiliate webpages. The premium affiliate webpages benefit by receiving some form of compensation for their participation, a sales channel from their specialized content. They also get to offer a value-added service to their viewers without having to search for and link to the products and services that relate to their content.

### 2. Advertising Network.

In this embodiment, the collection of keywords, associated products for sale, and advertising presentations used by the Context Sensitive Advertising Program are built for the needs of many different vendors and online businesses. These various businesses each subscribe to a list of keywords and associated advertisement presentations for their products. The vendors pay for the use of the system and effectively ‘subscribe’ to a list of keywords. The affiliate webpages get a wider source of sales and services to associate with their specialized content, and are compensated for their participation. When the ad program receives a request for a specific keyword advertisement, it determines which vendor that has subscribed to that particular keyword will be presented next, and it sends out the appropriate advertising presentation for the vendor it has selected.

### 3. Internal Advertising Method

A particular case of this second preferred embodiment is realized in an internal advertising method.

In this particular case, the collection of keywords, associated products for sale, and advertising presentations used by the Context Sensitive Advertising Program are built by a service provider for its own needs. Such a service provider might be an organization that provides Internet access and a significant amount of content, such as America Online. The web or other pages prepared by the service provider and the advertising on them are all created by the service provider. In other words, it is possible that the website system, the distributor system, the ad support system, and the advertiser system might all be owned and controlled by one overall entity.

Thus, in this particular case, the invention is applicable in a method of network advertising in which no affiliates and no plurality of vendors are involved.

It will be appreciated that variations of the foregoing three specific instances of the second preferred embodiment are possible. That is, a large service and content provider might allow vendors to subscribe to keywords, or might allow vendors to subscribe to keywords while keeping some keywords for its own advertising purposes.

The context-sensitive advertising presentation, in every embodiment, can be a simple image as in the example above, or an interactive element, as described in the first preferred embodiment. Because a companion element can be instantiated at the interactive advertising support system in either event, the simple image or the interactive element, or content for the interactive element, can be obtained from distant servers.

Conclusion

The invention has been discussed in general terms, and in very specific terms with respect to two particular examples. The invention is not limited to just these examples, and the scope of the invention is to be determined in accordance with the appended claims.

It will be appreciated that, although the examples have related to only Java and JavaScript, other compiled or interpreted computer languages could be employed to perform the steps and tasks outlined above. For example, C or C++ could be used instead of Java to produce executable object code. Per1 could be used instead of JavaScript to produce scripts.

The problems solved above relate to advertising, but the solution to the problems in advertising could be applied to other areas as well, such as non-advertising information sharing and displays.

Specific implementation details could be changed, such as the use of a function definition file in the second preferred embodiment, e.g. In practice, the functions defined in the function definition file could be themselves included in the statements comprising the primary target page. Other minor variations and changes will occur to those familiar with this field, and may be made without departing from the scope and spirit of the invention.

1. A context sensitive advertising method for use with an interactive computer display, comprising:
preparing a primary target file comprising a relation between one or more context sensitive display elements and corresponding keys;
displaying said target file with said context sensitive display elements;
detecting a user interaction with one of said context sensitive display elements; and
in response to said detecting of said user interaction, displaying an ad space based on the corresponding key of said one of said context sensitive display elements.

2. The context sensitive advertising method as set forth in claim 1, wherein said primary target file includes a reference to an ad program, and said ad program includes a function definition file having functions for displaying said ad space.

3. The context sensitive advertising method as set forth in claim 1, wherein said ad space comprises a visually distinct ad presentation that overlays at least a portion of said primary target file content.

4. The context sensitive advertising method as set forth in claim 3, wherein said ad space automatically closes after the lapse of a predetermined period of time in the absence of a user interaction with said ad space.

5. The context sensitive advertising method as set forth in claim 4, wherein said ad space remains open beyond said lapse of said predetermined period of time in response to a user interaction with said ad space.

6. The context sensitive advertising method as set forth in claim 3, wherein said displaying of said ad space is made further in response to said user interaction being detected for a time greater than a threshold period of time.

7. The context sensitive advertising method as set forth in claim 1, wherein said ad space is other than an overlay or popup window.

8. The context sensitive advertising method as set forth in claim 7, wherein said ad space is a dedicated ad table that is a feature of the content of said primary target file.

9. The context sensitive advertising method as set forth in claim 7, wherein said displaying of said ad space is made further in response to said user interaction being detected for a time greater than a threshold period of time.

10. The context sensitive advertising method as set forth in claim 2, wherein said step of displaying said ad space comprises:
loading an ad space target file having selection statements;
executing said selection statements so as to select, based on the corresponding key of said one of said context sensitive display elements, an ad space display management file; and
performing said displaying of said ad space based on 1l instructions contained in the contents of said selected ad space display management file.

11. The context sensitive advertising method as set forth in claim 10, wherein said contents of said ad space is used to display contextually relevant reference information.

12. The context sensitive advertising method as set forth in claim 11, wherein said contents of said ad space is selected from the group consisting of:
text content;
image content; and
hyperlink content.

13. The context sensitive advertising method as set forth in claim 10, wherein said contents of said ad space display management file indicates at least one interactive element for controlling display of said ad space.

14. The context sensitive advertising method as set forth in claim 10, further comprising:
predefining a collection of said keys, associated ad space, and corresponding ad space display management files for one or more advertising customers; and
using said keys and associated context sensitive display elements in one or more primary target files defining a network of affiliate publishers.

15. The context sensitive advertising method as set forth in claim 14, further comprising:
providing compensation to said affiliate publishers in exchange for said displaying of said ad space on said primary target files; and
charging a fee to said advertising customer when said display of said ad messages on said network of affiliate publishers corresponds to an ad message for said advertising customer.

16. The context sensitive advertising method as set forth in claim 14, further comprising:
providing subscriptions for said keys to one or more of said advertising customers;
when said user interaction with one of said context sensitive display elements is detected, determining which of said advertising customers have subscribed to the corresponding one of said keys; and
performing said displaying of said ad space based on said determination of said subscription status of said advertising customers to said keys.

17. The context sensitive advertising method as set forth in claim 1, wherein said context sensitive display element comprises the entire presentation content of said primary target file, wherein said corresponding keys are determined based upon the overall content of said primary target file, as opposed to individual keywords within said content, and wherein said user interaction is the act of opening said target file such that said contextually targeted ad spaces are displayed immediately upon opening said primary target file.

18. The context sensitive advertising method as set forth in claim 1, the step of preparing said primary target file further comprising:
periodically, automatically analyzing the content of said target file; and
determining said context sensitive display elements and said corresponding keys based upon said analysis.

19. The context sensitive advertising method as set forth in claim 1, the step of preparing said primary target file further comprising:
periodically analyzing the content of said target file by user text input in a user-initiated search query; and
determining said context sensitive display elements and said corresponding keys based upon said analysis.

20. The context sensitive advertising method as set forth in claim 1, the step of preparing said primary target file further comprising:
periodically analyzing the details of a user's computer operating environment; and
determining said context sensitive display elements and said corresponding keys based upon said analysis.
